(19) United States
(12) Patent Application Publication
(10) Pub. No.: US 2024/0005354 A1
(43) Pub. Date: Jan. 4, 2024

(54) SYSTEM AND METHOD OF PROVIDING MOBILE NUMBER LINKED TO REDEEMABLE AND SHAREABLE PROMOTIONS AND A CHECKOUT PROCESS

(71) Applicant: Redeem Technologies Inc., Dover, DE (US)

(72) Inventors: Toby RUSH, Roeland Park, KS (US); Kenneth E. CONKLIN, III, Olathe, KS (US); Joshua FREUDENHAMMER, Lenexa, KS (US)

(21) Appl. No.: 18/051,256

(22) Filed: Oct. 31, 2022

Related U.S. Application Data
(60) Provisional application No. 63/357,700, filed on Jul. 1, 2022.

(51) Int. Cl. G06Q 30/02; G06Q 20/36

(52) U.S. Cl. CPC G06Q 30/0239; G06Q 2220/00; G06Q 20/3678; G06Q 20/3672

(57) ABSTRACT

Systems, methods and computer-readable storage media are disclosed for receiving, at a server device having at least one processor, data associated with a user computing device, the data being associated with claiming a benefit and minting a non-fungible token (NFT) or dot associated with the benefit in connection with the data. The dot can be linked to a unique code such as a mobile phone number. The dot is recorded on a blockchain network and stored in a user wallet (that can be onboarded or created via use of the phone number as well) that is linked also to the mobile phone number. Redemption and use of the dot can be accessed by the user only needing to enter their known phone number to obtain the benefit in a number of different contexts.

### PRIORITY CLAIM

The present application is a non-provisional patent application of provisional application No. 63/357,770 filed on Jul. 1, 2022, the contents of which are incorporated herein by reference.

### TECHNICAL FIELD

The present disclosure generally relates to new approaches to creating or onboarding a wallet for holding one or more non-fungible tokens based on a unique code such as a telephone number. The disclosed concept generally enables a phone number to be linked to a redeemable and shareable non-fungible token (also called a “dot” herein) and other promotions and the use of the unique code for redemption processes.

### BACKGROUND

Discounts, coupons, gift cards and other redeemable products are froth with friction for consumers and brands. In many instances, the availability of obtaining a discount, for example, requires a user to use a coupon, or buy a gift card, or register for a service, and so forth. Often on-line users have opportunities as part of a purchase process to enter a “promo code” for a promotion. However, the “promo code” can be difficult to remember and complicated. Further, there is no real mechanism to track discounts or other benefits for users and they are limited often to different disparate redemption approaches across different businesses. There is no consistency in how users obtain and redeem discounts.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 illustrates a general blockchain network representing different nodes each communicating with each other, according to some aspects of the present disclosure;

FIG. 2A illustrates a portion of a claiming process for claiming a non-fungible token (NFT) or dot, according to some aspects of the present disclosure;

FIG. 2B illustrates another portion of the claiming process for claiming the NFT or dot, according to some aspects of the present disclosure;

FIG. 2C illustrates a database or table that correlates a phone number to a wallet and/or an NFT/dot ID, according to some aspects of this disclosure;

FIG. 2D illustrates a method from the standpoint of a server device, according to some aspects of the present disclosure;

FIG. 2E illustrates a method from the standpoint of a user computing device, according to some aspects of the present disclosure;

FIG. 3A illustrates a portion of a redemption process for redeeming an NFT/dot, according to some aspects of the present disclosure;

FIG. 3B illustrates another portion of the redemption process, according to some aspects of the present disclosure;

FIG. 3C illustrates a transaction at a company website in which a benefit associated with a redeemable NFT or dot is applied, according to some aspects of the present disclosure;

FIG. 3D illustrates a transaction at a company point-of-sale (POS) in which a benefit associated with a redeemable NFT or dot is applied to a transaction, according to some aspects of the present disclosure;

FIG. 3E illustrates a method embodiment from the standpoint of the redemption system, according to some aspects of the present disclosure;

FIG. 3F illustrates another method embodiment from the standpoint of the redemption system, according to some aspects of the present disclosure;

FIG. 3G illustrates a method embodiment from the standpoint of the user computing device, according to some aspects of the present disclosure;

FIG. 3H illustrates a method embodiment from the standpoint of a company computing device, according to some aspects of the present disclosure;

FIG. 4A illustrates another aspect of selecting to use a benefit associated with a redeemable NFT or dot, according to some aspects of the present disclosure;

FIG. 4B illustrates an aspect of linking different types of blockchain-based wallets, according to some aspects of the present disclosure;

FIG. 4C illustrates a graphical user interface for the wallet, according to some aspects of the present disclosure;

FIG. 4D illustrates a graphical user interface for a branded sub-wallet, according to some aspects of the present disclosure;

FIG. 4E illustrates a method of interacting with the user via a wallet interface according to some aspects of the disclosure; and

FIG. 5 illustrates an example computing device suitable for performing various functions disclosed herein, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment. Such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed herein are systems, methods and computer-readable storage media for providing a wallet that can hold non-fungible tokens (NFTs) or redeemable NFTs (rNFTs) and that is associated with a unique number, code (numeric or alphabet or alphanumeric) such as, for example, a user's telephone number. In this disclosure, a redeemable NFT or similar object is called a “dot” which can be used to describe NFTs or other digital objects that can be used as next generation coupons or promo codes but can be used for other functions as well. Thus, dots can be minted and held in wallets as a digital object.

By using a unique code such as a known user's phone number, consumers are only required to remember their mobile number when accepting and redeeming the benefit or financial reward. Otherwise, to obtain or redeem a reward or discount, they need to buy and then remember to bring a physical card or remember a difficult promotion code or cut a coupon, etc. The approach disclosed herein is to tie the benefit to an easily-remembered number and to enable companies to attribute, track, be dynamic, etc., by creating dots for each consumer and for each campaign. Then, with a particular advertising or promotional campaign, the company has the ability to track gift cards, coupons, discounts, etc., to consumers for the campaign. Also disclosed is the ability for consumers to easily share campaigns (if the campaign is shareable) via sharable dots and companies are able to track sharing for each campaign to increase the virality of the campaign and the brand of the company as well. While the unique code used herein is typically described as a phone number that the user can easily remember, the user may choose any other number or alpha-numeric code as well that can be used. The code used does not have to be a mobile phone number, home phone number or business phone number.

The approach is to link an individual's mobile phone number to a Web3wallet and/or datastore (i.e. database) to store and retrieve redeemable financial products or other benefits for use in online shopping carts, point-of-sale terminals, in-app use, etc., where the individual only needs their mobile number (or any chosen code) to retrieve and redeem any respective redeemable promotion for a respective company when purchasing a good or service. Each redeemable financial promotion stored in an individual's wallet will be a dot or similar technical construct that is redeemable.

This overview is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The approach disclosed herein addresses several points raised above. One aspect of this disclosure introduces a number of concepts. One example method includes receiving, at a server device having at least one processor, data associated with a user computing device, the data being associated with claiming a benefit; validating the data as being associated with a valid campaign to yield a validation; based the validation, transmitting, from the server device, a communication to the user computing device that launches a messaging application on the user computing device, creates and prepopulates a message ready for the user to send; receiving, based on the user confirming to send the message from the user computing device, the message from the user computing device, the message including a unique code associated with the user computing device; minting a dot associated with the benefit in connection with the data, wherein the dot is recorded on a blockchain network that includes a distributed set of nodes operating a distributed consensus algorithm and records transactions on a distributed ledger such that each transaction is immutably recorded; linking the dot to a wallet for the user via the unique code associated with the user computing device; and transmitting a confirmation response to the user computing device to confirm that the user has claimed the benefit.

As noted above, the unique code can in one aspect be a user's phone number or other chosen code by the user.

An example system can include one or more processors and a computer-readable storage medium storing instructions which, when executed by the one or more processors, causes the one or more processors to perform operations. The operations can include receiving data associated with a user computing device, the data being associated with claiming a benefit, validating the data as being associated with a valid campaign to yield a validation and, based the validation, transmitting a communication to the user computing device that launches a messaging application on the user computing device, creates and prepopulates a message ready for the user to send. The operations can include receiving, based on the user confirming to send the message from the user computing device, the message from the user computing device, the message including a unique code associated with the user computing device, minting a dot associated with the benefit in connection with the data, wherein the dot is recorded on a blockchain network that includes a distributed set of nodes operating a distributed consensus algorithm and records transactions on a distributed ledger such that each transaction is immutably recorded, linking the dot to a wallet for the user via the unique code associated with the user computing device and transmitting a confirmation response to the user computing device to confirm that the user has claimed the benefit.

In another example, a method can include receiving, at a user computing device, an interaction associated with a user that initiates a request associated with a benefit; transmitting the request to a server device; receiving, based on the request, a communication from the server device; initiating, based on the communication, a messaging application on the user computing device; generating, via the messaging application, a message prepopulated for transmission to the server device; upon a confirmation from the user to send the message, transmitting the message to the server device, wherein the server device identifies via the message a unique code associated with the user computing device, mints a dot associated with the benefit and stores the dot in a wallet associated with the unique number, wherein the dot is recorded on a blockchain network that includes a distributed set of nodes operating a distributed consensus algorithm and records transactions on a distributed ledger such that each transaction is immutably recorded; and receiving a confirmation response at the user computing device to confirm that the user has claimed the benefit.

An example system can include one or more processors and a computer-readable storage medium storing instructions which, when executed by the one or more processors, causes the one or more processors to perform operations. The operations can include receiving, at a user computing device, an interaction associated with a user that initiates a request associated with a benefit; transmitting the request to a server device; receiving, based on the request, a communication from the server device; initiating, based on the communication, a messaging application on the user computing device; generating, via the messaging application, a message prepopulated for transmission to the server device; upon a confirmation from the user to send the message, transmitting the message to the server device, wherein the server device identifies via the message a unique code associated with the user computing device, mints a dot associated with the benefit and stores the dot in a wallet associated with the unique number, wherein the dot is recorded on a blockchain network that includes a distributed set of nodes operating a distributed consensus algorithm and records transactions on a distributed ledger such that each transaction is immutably recorded; and receiving a confirmation response at the user computing device to confirm that the user has claimed the benefit.

In another aspect, a method can include receiving an indication from a company computing device of an intent of a user to apply a benefit from a dot held in a user wallet, wherein the indication includes a unique code associated with a user computing device and a brand identifier; confirming, based on a link between the unique code and the user wallet, that the user wallet contains the dot and that the benefit is available to yield a confirmation; based on the confirmation, returning to the company computing device a response identifying the benefit to apply the benefit to an action performed by the user; and performing an action on the dot contained in the user wallet including either burning the dot or performing another action on the dot associated with the action performed by the user.

An example system can include one or more processors and a computer-readable storage medium storing instructions which, when executed by the one or more processors, causes the one or more processors to perform operations. The operations can include receiving an indication from a company computing device of an intent of a user to apply a benefit from a dot held in a user wallet, wherein the indication includes a unique code associated with a user computing device and a brand identifier; confirming, based on a link between the unique code and the user wallet, that the user wallet contains the dot and that the benefit is available to yield a confirmation; based on the confirmation, returning to the company computing device a response identifying the benefit to apply the benefit to an action performed by the user; and performing an action on the dot contained in the user wallet including either burning the dot or performing another action on the dot associated with the action performed by the user.

In yet another aspect, a method can include receiving an indication on a user computing device of an intent of a user to apply a benefit from a dot held in a user wallet; transmitting a request to a company computing device either directly or through a point-of-sale device, the request including a unique code associated with the user computing device, wherein a redemption system receives the unique code and a data associated with a transaction from the company computing device and verifies, based on a link between the unique code and the user wallet, that the user wallet contains the dot and that the benefit is available to yield a verification; and, based on the verification, receiving from the user and on the user computing device a confirmation to apply the benefit to an action performed by the user, wherein based on the confirmation, the redemption system performs an action on the dot contained in the user wallet including either burning the dot or performing another action on the dot associated with the action performed by the user. The intent of the user to apply the benefit from the dot held in the user wallet is in connection with a transaction.

An example system can include one or more processors and a computer-readable storage medium storing instructions which, when executed by the one or more processors, causes the one or more processors to perform operations. The operations can include receiving an indication on a user computing device of an intent of a user to apply a benefit from a dot held in a user wallet; transmitting a request to a company computing device either directly or through a point-of-sale device, the request including a unique code associated with the user computing device, wherein a redemption system receives the unique code and a data associated with a transaction from the company computing device and verifies, based on a link between the unique code and the user wallet, that the user wallet contains the dot and that the benefit is available to yield a verification; and, based on the verification, receiving from the user and on the user computing device a confirmation to apply the benefit to an action performed by the user, wherein based on the confirmation, the redemption system performs an action on the dot contained in the user wallet including either burning the dot or performing another action on the dot associated with the action performed by the user.

In yet another aspect, a method can include receiving an indication from user computing device and at a company computing device of an intent of a user to apply a benefit from a dot held in a user wallet, wherein the indication includes a unique code associated with a user computing device and a brand identifier; transmitting the unique code and a transaction identification to a redemption system, wherein the redemption system confirms, based on a link between the unique code and the user wallet, that the user wallet contains the dot and that the benefit is available to yield a confirmation; based on the confirmation, receiving at the company computing device a response identifying the benefit to apply the benefit to an action performed by the user; and applying the benefit to a transaction of the user and associated with the benefit, wherein the redemption system performs an action on the dot contained in the user wallet including either burning the dot or performing another action on the dot associated with the transaction.

An example system can include one or more processors and a computer-readable storage medium storing instructions which, when executed by the one or more processors, causes the one or more processors to perform operations. The operations can include receiving an indication from user computing device and at a company computing device of an intent of a user to apply a benefit from a dot held in a user wallet, wherein the indication includes a unique code associated with a user computing device and a brand identifier; transmitting the unique code and a transaction identification to a redemption system, wherein the redemption system confirms, based on a link between the unique code and the user wallet, that the user wallet contains the dot and that the benefit is available to yield a confirmation; based on the confirmation, receiving at the company computing device a response identifying the benefit to apply the benefit to an action performed by the user; and applying the benefit to a transaction of the user and associated with the benefit, wherein the redemption system performs an action on the dot contained in the user wallet including either burning the dot or performing another action on the dot associated with the transaction.

The foregoing, together with other features and embodiments, will become more apparent upon referring to the following specification, claims, and accompanying drawings.

### Example Embodiments

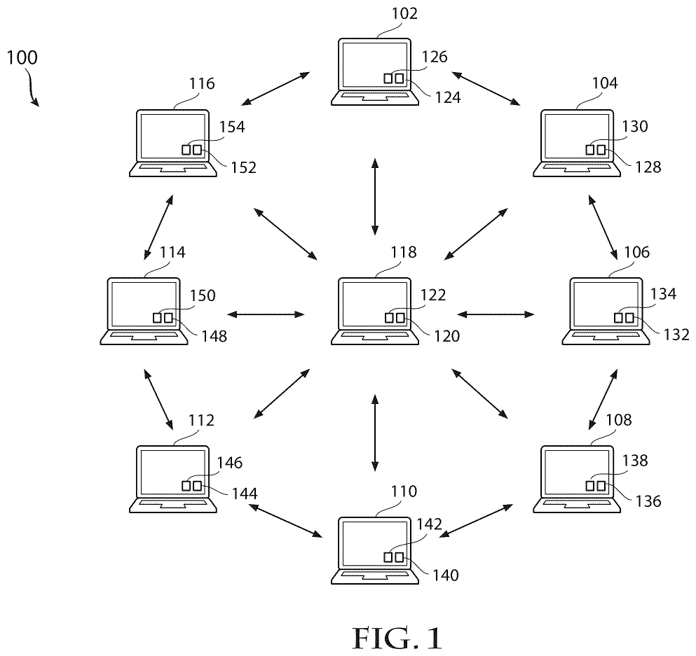

Disclosed are systems, methods, and computer-readable storage media that provides for the ability to enhance the simplicity of using non-fungible tokens (NFTs) or dots in connection with a wallet. The wallet and the dots can be minted or created through the use of a code such as a telephone number. As dots are typically recorded on a blockchain, FIG. 1 is first discussed with the basic structure of a blockchain network that can be applied to the use of dots and in connection with other blockchain uses. As noted above, in this application, redeemable NFTs or dots with their various uses are called “dots.”

Dots are cryptographic assets on a blockchain with unique identification codes and/or metadata that distinguish them from each other. Unlike cryptocurrencies like bitcoin, they cannot be traded or exchanged at equivalency. Thus, the use of dots differs from fungible tokens like cryptocurrencies, which are identical to each other and, therefore, can serve as a medium for commercial transactions. Dots are unique cryptographic tokens that cannot be replicated as they are each unique. They can represent real-world items like artwork and real estate and in the examples disclosed herein, the dots are used to represent real-world benefits like discounts, access to events, gift card amounts, or other rewards. By tokenizing these real-world tangible benefits enables accessing the benefit, redeeming the benefit, sharing the benefit and tracking the actions associated with the benefit and perhaps part of a campaign possible. Using dots also reduces the probability of fraud.

FIG. 1 illustrates a general blockchain network representing different nodes each communicating with at least one other node, according to some aspects of the present disclosure. Such a blockchain can be used to record dots on a distributed ledger across the nodes. The blockchain network 100 includes a plurality of distributed nodes or computing devices 102, 104, 106, 108, 110, 112, 114, 116, 118. Each of these nodes and computing devices includes a component, module or software as part of a distributed consensus algorithm 120, 124, 128, 132, 136, 140, 144, 148, 152 in which transactions that are to be processed by the blockchain network are voted upon by the distributed consensus algorithm. Blockchain networks 100 have various consensus mechanisms, including proof of stake, multi-signature, and PBFT (practical Byzantine fault tolerance). Any of these different types of blockchain can be applicable to this disclosure. For example, some applicable blockchain networks can include Ethereum Avalanche, Cardano, Hyperledger Fabric, the IBM blockchain, Tron, Binance Smart Chain, and so forth. Other approaches to consensus are also provided herein.

Another component, module or software provide a distributed ledger 122, 126, 130, 134, 138, 142, 146, 150, 154. The general operation of the blockchain is that it will record transactions across the distributed ledger 122, 126, 130, 134, 138, 142, 146, 150, 154 that are voted upon by the consensus algorithm 120, 124, 128, 132, 136, 140, 144, 148, 152. The recorded transactions (such as the creation or redemption of a dot, a sale or transfer of a cryptocurrency, or a confirmation of an event or of a validity of a document), are immutable in that the way the distributed ledger works is through adding blocks of data (or a group of transactions) to the ledger in which each block is connected via a hash to data in a previous block. The blockchain network 100 is a distributed database (distributed ledger) that maintains a continuously growing list of ordered records in the respective blocks. The blocks are linked using cryptography. Each block contains a cryptographic hash of the previous block, a timestamp, and transaction data. The blockchain network 100 is a decentralized, distributed and public or private digital ledger that is used to record transactions across many computers so that the record cannot be altered retroactively without the alteration of all subsequent blocks and the consensus of the network. The data regarding a transaction proceeds through a transition from one state (the pre-ledger state) which could be hacked or shared and which may typically be stored in a memory which is not necessarily secure to another state (a post-ledger state) in which the transaction or data is immutable to the extent that the transaction cannot be altered without the consensus of the blockchain network 100. These characteristics cannot be obtained via a generic computer storing data in a memory or on a generic hard drive. In such a case, the structure of a generic computer does not enable immutable storage of data on the memory of the computer or in a block structured as it is described above on a blockchain network.

The blockchain network 100 can be used to record data or transactions related to a number of different use cases. While the focus of this application is on the use of a simple number or code (e.g., such as a phone number) to link to a user wallet and dots created and stored in the wallet and their later redemption for a benefit such as a discount, this idea can also apply to many different types of benefit. Some of these benefits are in the classical world such as discounts for on-line sales or discounts for point-of-sale brick and mortar purchases. Access or use of dots can be at a kiosk or automated product distribution device such as a food or product dispenser. Other benefits can be tied to existing blockchain-based uses as well.

The following is an example non-limiting summary of the different adaptations for the use of the blockchain network 100, each of which can include a dot benefit used in connection with the other blockchain application. While this list relates to a number of different uses of the blockchain network 100, generally in the context of this disclosure, dots could be created and redeemed in the context of any of these uses of the blockchain network 100. For example, one benefit of the blockchain is for payment processing and money transfers. Transactions processed over a blockchain could be settled within a matter of seconds and reduce (or eliminate) banking transfer fees. Dots can be used in connection with benefits or processes associated with payment processing or money transfers. In one example, a bitcoin transaction to purchase an item could occur on one blockchain network, while a discount for the purchase can be managed through the use of a dot managed on a separate blockchain.

The blockchain network 100 can be used for monitoring of supply chains. Using the blockchain network 100, businesses could pinpoint inefficiencies within their supply chains quickly, as well as locate items in real time and see how products perform from a quality-control perspective as they travel from manufacturers to retailers. The ability to easily create in a simple manner a dot using a code such as a telephone number can be used in connection with supply chain management issues. The blockchain network 100 can be used for digital identifications (IDs). Some companies are experimenting with blockchain technology to help people control their digital identities, while also giving users control over who accesses that data. The ability to create and use dots can be also connected to a blockchain use of a digital ID where a particular redemption process might require or be more secure with a blockchain-based digital ID to confirm the transaction. The blockchain network 100 can be used for data sharing. The blockchain network 100 could act as an intermediary to securely store and move enterprise data among industries. Again, the use of dots as disclosed herein can grant a benefit such as a right to store, move or have access to data.

Another use of the blockchain network 100 can be for copyright and royalties protection. The blockchain network 100 could be used to create a decentralized database that ensures artists maintain their music rights and provides transparent and real-time royalty distributions to musicians. Blockchain could also do the same for open-source developers. In connection with the management of such rights that can be implemented on the blockchain, the use of dots in the manner disclosed herein can enable access or benefits associated with such rights or royalties.

The blockchain network 100 can be used for an Internet of Thing (IoT) network management. The blockchain network 100 could become a regulator of IoT networks to identify devices connected to a wireless network, monitor the activity of those devices, and determine how trustworthy those devices are and to automatically assess the trustworthiness of new devices being added to the network, such as cars and smartphones. The benefits described herein with respect to dots and how they are created and redeemed can also relate to IoT devices and their use. For example, a dot may grant a benefit for the right to access an IoT device for a period of time in which the IoT device is separately managed by a blockchain network 100.

The blockchain network 100 can be used for healthcare. Healthcare payers and providers are using blockchain to manage clinical trials data and electronic medical records while maintaining regulatory compliance. In connection with this use, an example of the use of dots can be to provide any benefit, payment, discount, and so forth with respect to healthcare.

The above description illustrates how any transaction such as a sale using fiat dollars, or a bitcoin transaction, or any other type of transaction that might be managed on a blockchain network, can also have an associated benefit, discount, gift card, reward, or loyalty component which can be implemented using a dot linked to a mobile phone number as disclosed herein which can be managed on a different blockchain network 100.

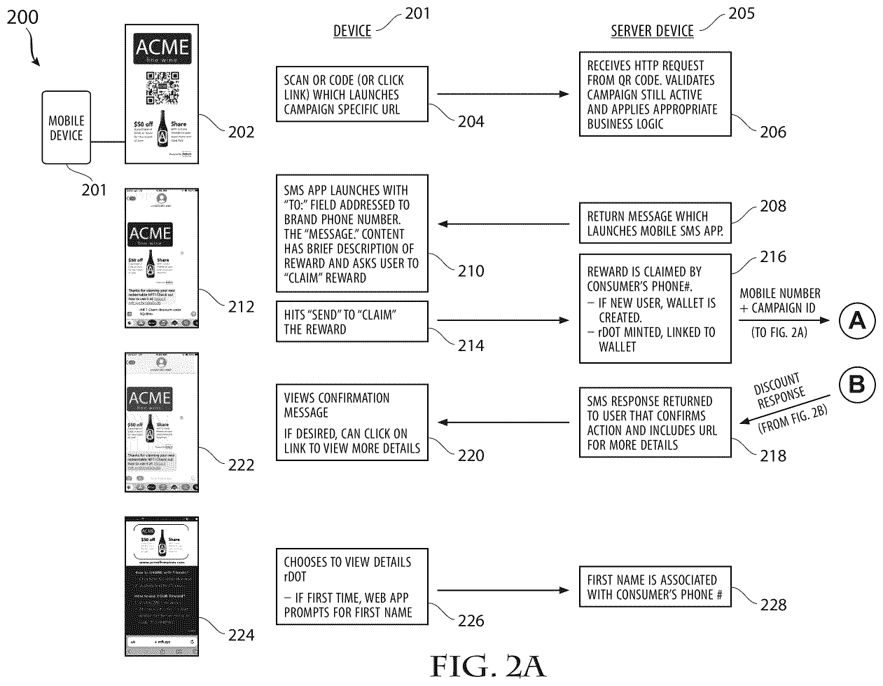

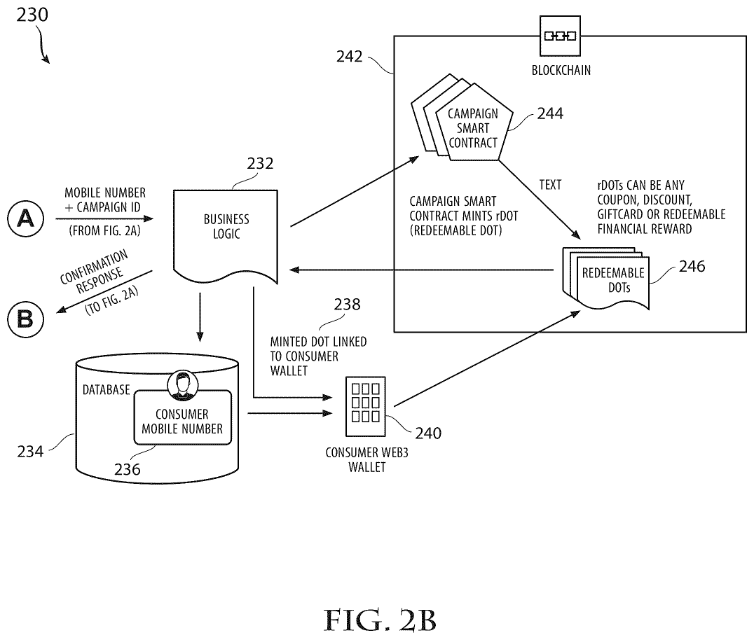

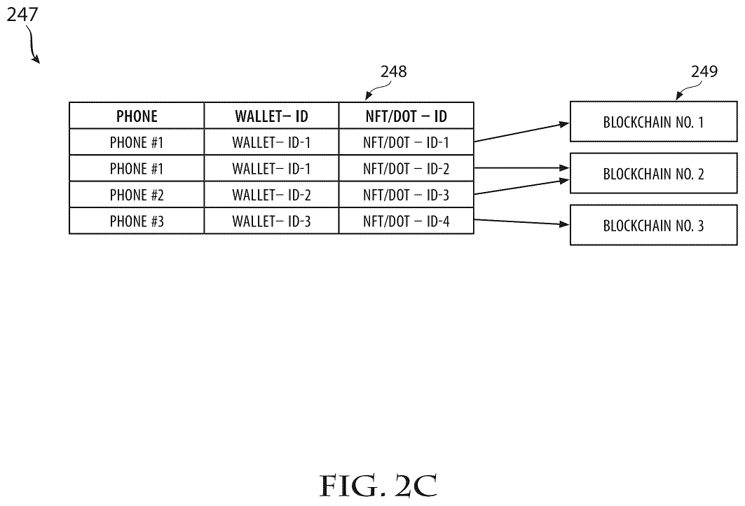

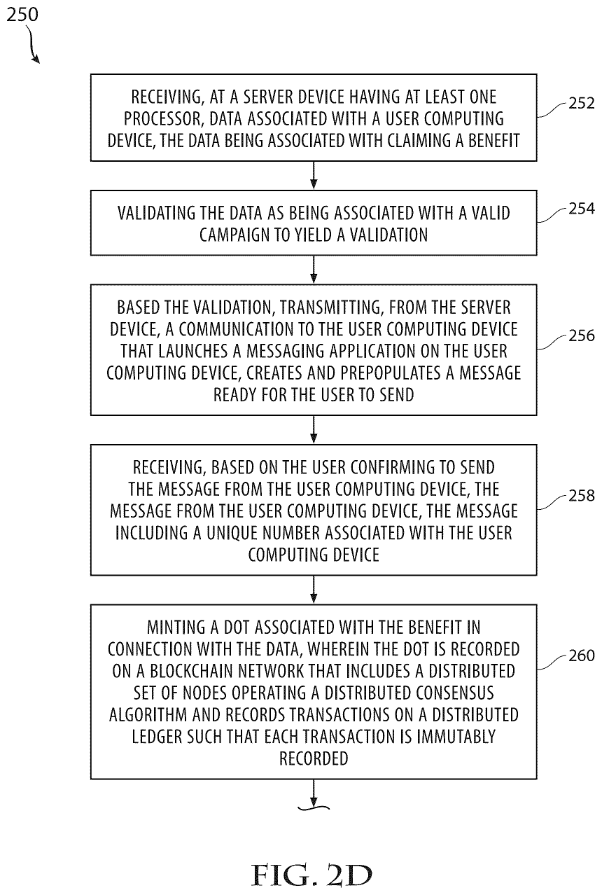

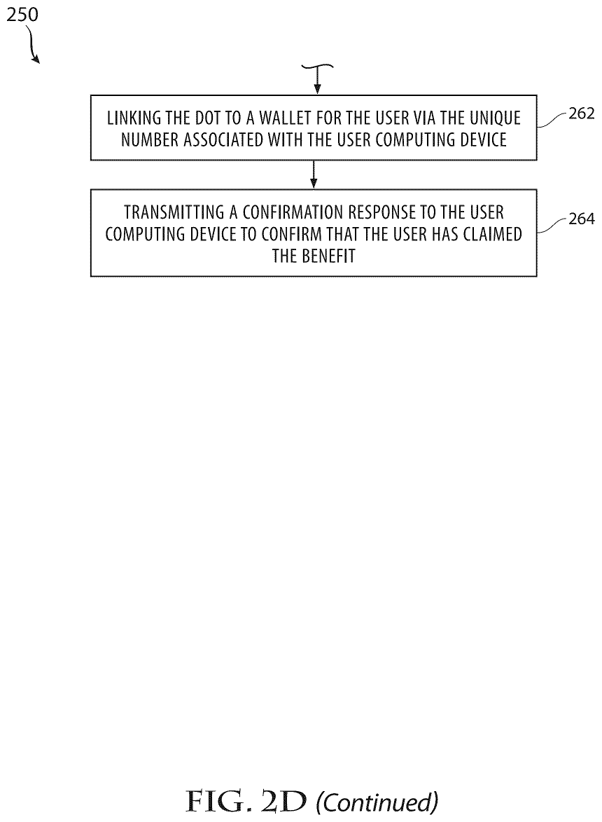

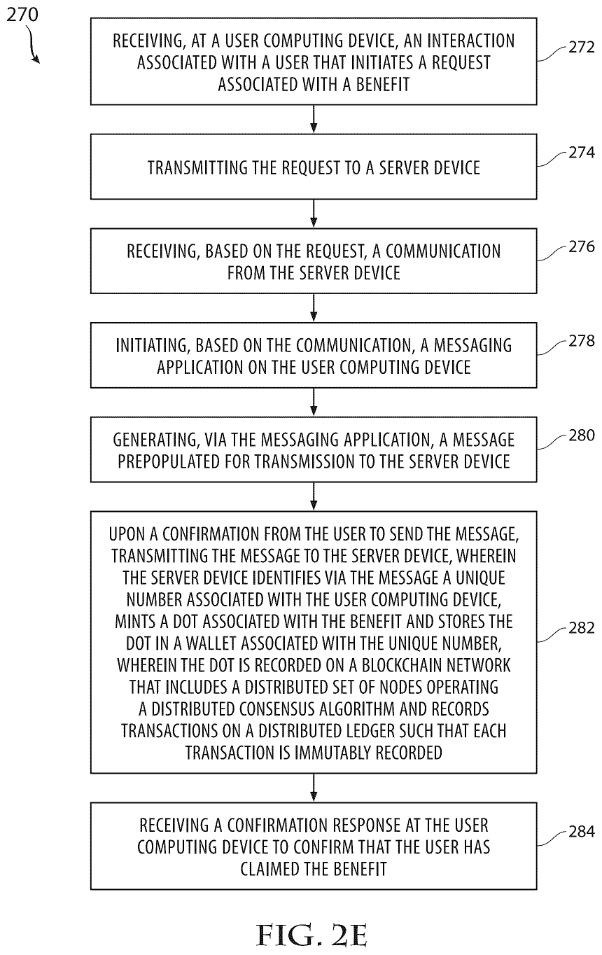

The first part of the process disclosed herein relates to how a user might identify a potential benefit such as discount illustrated or made available via a QR Code (quick response code) seen on an item in a store and “claim” the benefit. A QR code is a type of matrix barcode or visual object which a user can take a picture of using a mobile device and the optical label contains information to enable some action to be taken. In claiming the benefit, a dot and in a first instance a wallet would have to be created to store the dot. FIG. 2A illustrates the first portion of a claiming process. The process 200 can begin with a consumer device, which can be any computing device 201 whether mobile or not, that can click a link shown on a user interface 202 or can scan a QR Code or any visual object with the computing device 201 which can launch a campaign-specific universal resource locator (URL) 204. This triggering step causes the computing device to send an HTTP (hyper-text protocol) request to a server device 205 that receives the HTTP request, validates the request and apply the appropriate business logic 206. The server device 205 returns a message which launches a mobile short messaging server (SMS) application 208. Note that any type of message can be sent and it is not limited to an SMS message. For example, the user may typically communicate with people through Facebook Messenger or WhatsApp or email. Any communication type or protocol can be used in this context and the communication does not have to be through a messaging application but can simply be across a network. The message is returned to the computing device that launches an application and can pre-populate text on a new message 210 such that the “send-to” data is the right mobile number for the server device 205. This can be the “send to” mobile number which is associated with the company handling the promotion requests. A user interface 212 shows an example of the created and configured message. There are several advantages to this approach. It is much easier for the user to initiate the process as it uses familiar technology such as a messaging application. Further, by using a messaging application that is tied to the user's phone number, the user can hit an object “send” or “claim” 214 to send the message to the server device 205. In this regard, the process of performing one or more of onboarding or creating a new wallet, generate and storing a dot associated with a benefit can be achieved through a one-click or two-click interaction by the user. The first click can be a scan of the QR code or a user clicking on a link, and the second click can be hitting “send” on the preconfigured message that then initiates the downstream processing with no more interaction by the user.

When the unique code is not a phone number that can be used in a messaging application, another communication protocol could be used to perform the communication function described above. In one aspect, the user can be given the option to use a different number/alphanumeric code than a phone number and the interaction might transition to a different communication mode than a messaging application that relies on phone number. In another aspect, the system may use a messaging application with pseudo numbers for communication purposes but still receive the data necessary to link the unique code from the user to dots. In this case, where a chosen code could be a duplicate of another code (which issue does not arise with phone numbers that are already uniquely assign) a disambiguation step could occur in which the chosen unique code is confirmed against a database to be unique for that user. After the confirmation, the user could then use the unique code.

The server device 205 then causes the reward or benefit to be claimed by that user 216 in connection with their mobile phone number, which is known because that is sent along with the message. The message can also be prepopulated with a campaign identifier that can indicate which benefit or discount is associated with the original QR code or link. If the user is new to the system, then a new wallet is created on the blockchain network (shown in FIG. 2B) and a new dot is minted and linked to the wallet or placed in the wallet 216. This process can be characterized as an onboarding of a new wallet into the system in a more simple and automated way that requires minimal interaction by the user.

In one example, the wallet that is created can be a “Web3” wallet. Web3 wallets are useful for accessing the Web3 space, decentralized finance (DeFi), and cryptocurrency space. Web3 wallets are digital wallets. They can store digital assets such as dots or fungible tokens like bitcoin. The Web3 wallet also opens the door to the cryptocurrency realm, allowing users to interact with digital applications on various blockchains. In turn, wallets help users access an extensive ecosystem of dApps (decentralized applications). Various Web3 wallets include for example, MetaMask, Coinbase Wallet, Argent, Trust Wallet and Rainbow. Those of skill in the art will be familiar with these various wallets and any such wallets can be used as the basis for the disclosed wallet.

Cryptocurrency wallets often have a non-custodial characteristic, which means that wallet owners can store digital assets without the need for an intermediary or middleman. This means that users remain in complete control of all their assets as no one else has access to their tokens. However, with exclusive access, all the responsibility lies with the user, meaning that it is essential to keep private keys secret.

Along with the ability to host digital assets, wallets often provide additional functionalities. For instance, this makes it possible to utilize Web3 wallets to send and swap tokens. As such, cryptocurrency wallets can be used to fully manage a user's assets, including a way to acquire additional tokens. In one aspect, the wallets can be held in a custodial fashion in which public and private keys associated with a wallet can be held by the redemption server or the server device 205 managing the creation and redemption of redeemable dots. This is the approach typically used herein to simplify the interactions of the user in connection with claiming dots.

In general, Web3 refers to the latest generation or phase of the internet. The previous generations are Web1 and Web2, phases most people are more familiar with. The three internet generations characterized by Web1, Web2 and Web3 didn't start at a specific point and weren't initiated by a single entity to revolutionize the internet. However, each phase has its own characteristics where Web1 was static, Web2 dynamic, and Web3 is decentralized. In one aspect, the approach might be a Web2.5 approach in which the system is partially decentralized. In this regard, there can be an immutable ID or record on the blockchain that has some information associated with the process, but then users may need to access that information via an application programming interface (API) or other interface. The approach might then be partially decentralized in this regard.

With decentralization being a central concept in the latest phase of the internet, it is predominated by decentralizing data. Unlike Web2, there aren't single centralized entities that own data. Instead, the data is distributed and shared. Moreover, Web3 also ultimately solves the issue with companies owning large sets of personal information as users control their own data.

Within the Web3 ecosystem, another component relates to the use of dApps (or decentralized applications). These are decentralized applications that are generally blockchain-based, and the largest ecosystem of dApps is currently hosted on the Ethereum blockchain. With the decentralization aspect of dApps, it is possible to develop powerful applications that remove various issues that come with centralization, including a single point of failure. As noted above, the use of dots and their creation and redemption processes disclosed herein can be easily integrated into a Web3 decentralized world.

This disclosure returns to the discussion of FIGS. 2A and 2B. The phone number and optionally a campaign identifier are transmitted at point “A” to the business logic shown in FIG. 2B. The campaign identifier can relate to an advertising campaign, limited time discount, or a particular promotion. At point “B”, a confirmation response from the business logic shown in FIG. 2B is received at the server device 205 and a message response is returned to the user computing device 218 that confirms the action and can include more details. The user views the confirmation message 220 via a graphical user interface 222 and can click on the link for more details. The details of the processing of the business logic will be discussed below with reference to FIG. 2B.

The user interface 224 can represent the graphical data provided to the user when they click on the link for more details. If this is the first time the user has accessed a discount in this system, the web application can prompt the user for their first name 226 and associate the company name with the user's phone number 228 or other unique code chosen by the user.

FIG. 2B includes the framework which can be called a redemption system 230 which receives from point “A” the unique code and the campaign identifier from the computing device of FIG. 2A. The business logic 232 will send the confirmation response at point “B” to the computing device in FIG. 2A. The business logic 232 will cause a database 234 to store the user's unique code 236 and uses that data to mint a dot linked 238 to the consumer's wallet 240. If this is the first time the user has used the system, then a wallet 240 is created automatically for the user and linked to their unique code (i.e., telephone number). A blockchain network 242 is used which can run a smart contract 244 that mints the dots. The dots can be any benefit, coupon, discount, giftcard or redeemable financial reward. The redeemable dots are stored 246 on the blockchain 242 in any manner that involves the basic blockchain processes outlined in FIG. 1 and that changes the state of the data from just general data (for a new dot or transaction) to an immutable recording on the blockchain 242 of a transaction.

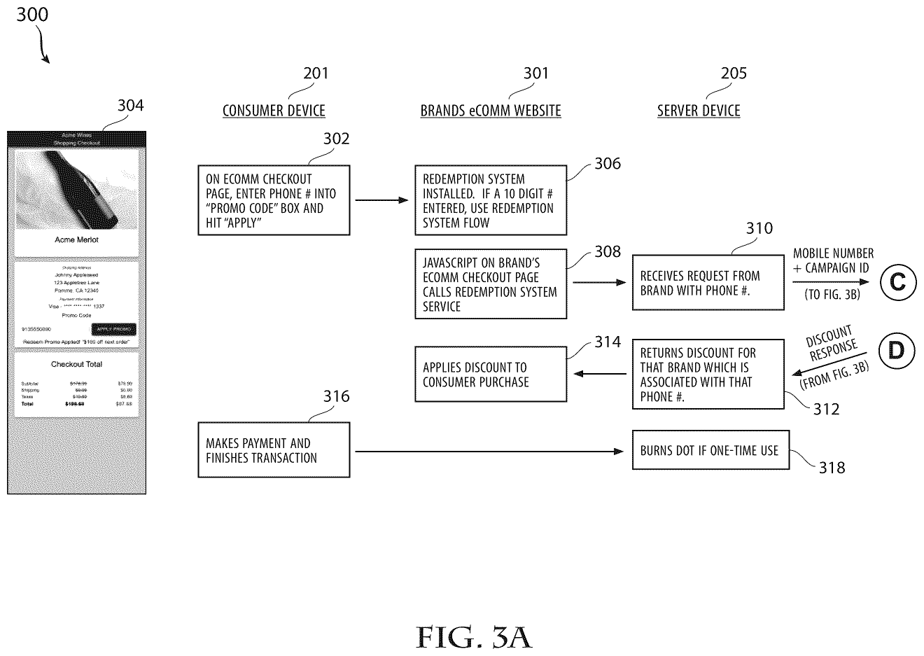

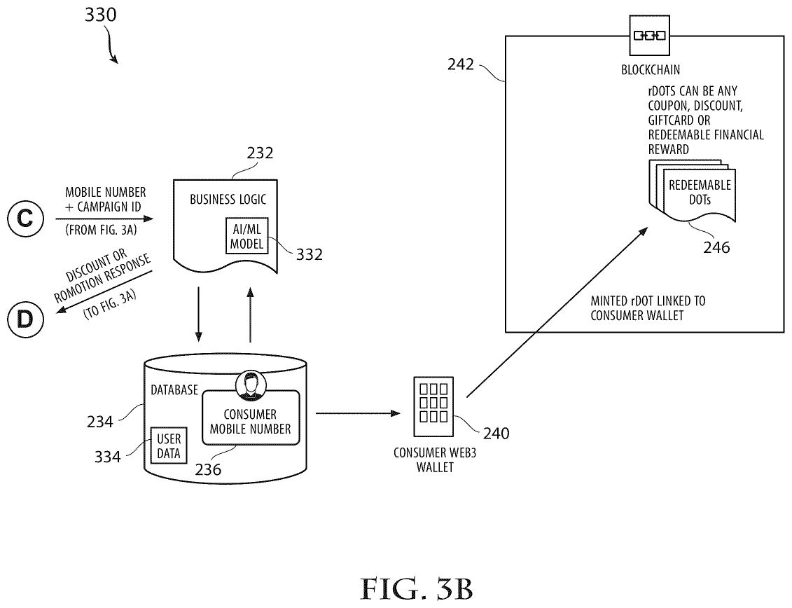

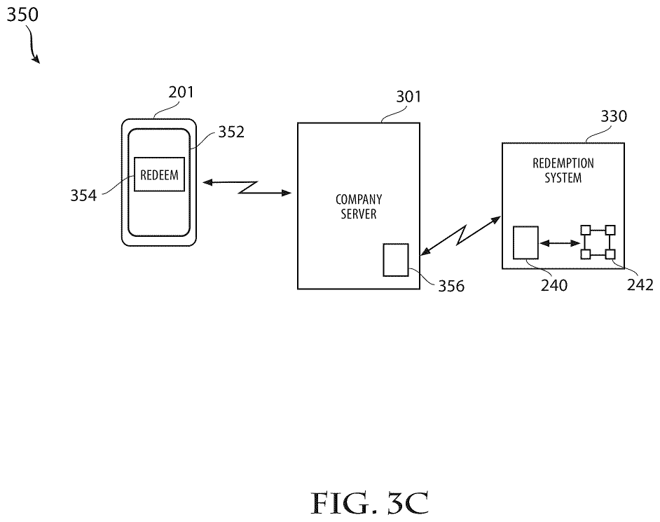

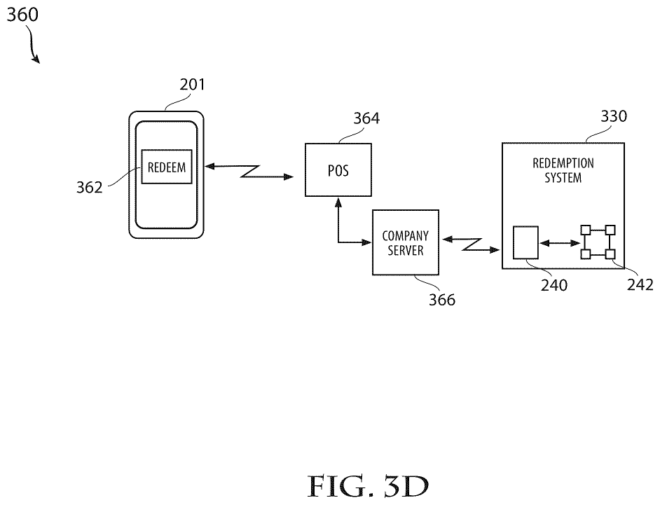

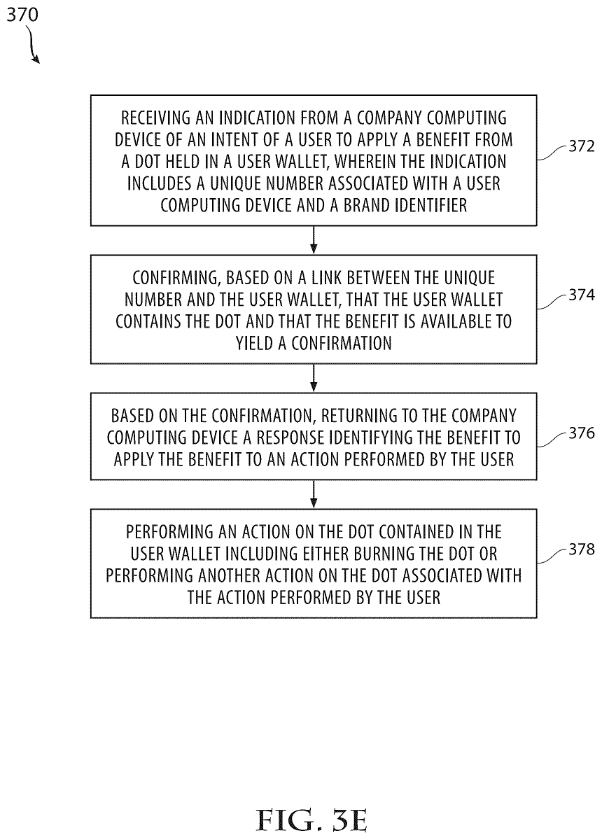

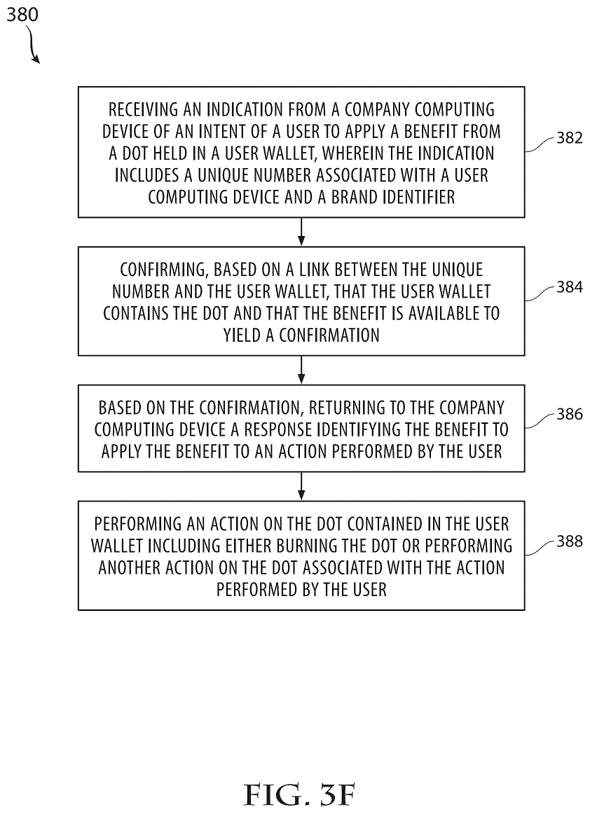

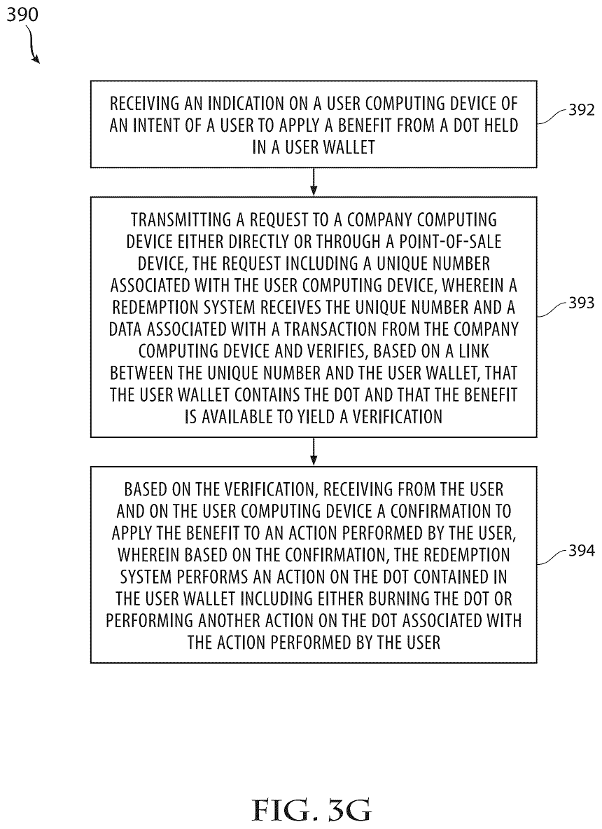

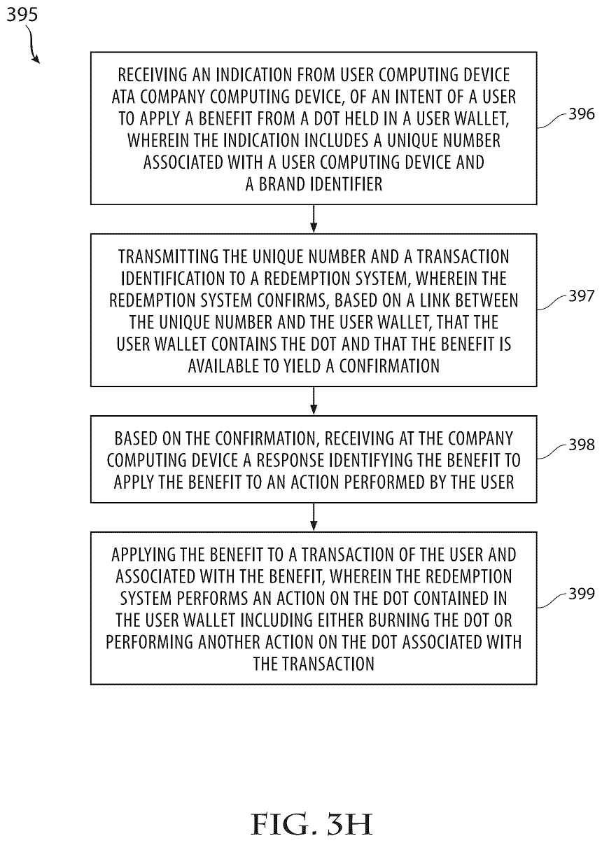

The wallet 240 may be hosted in a custodial or non-custodial manner. Custodial wallets are wallet services offered by a centralized business such as a cryptocurrency exchange. Custodial wallets have certain benefits, such as less user responsibility regarding private key management. When a user outsources wallet custody to a business, they are essentially outsourcing their private keys to that institution. The individual user is not responsible for protecting the private key to the wallet and therefore places trust in the business keeping the private key safe. In one example, the redemption platform 230 can be the custodian of the wallets that are created for the use of redeemable dots. When a user wishes to use a dot stored in a custodial wallet 240, they will provide their unique code such as their phone number, click on a link, scan a QR code, or perform some other operation to initiate the redemption process (outlined in FIGS. 3A, 3B). The redemption platform 230 will manage the process of providing the public key of the location to where the user wishes to use the dot and then provide the private key to complete the transaction. This enables the use of the dot to be transparent to the user and enables the user to simply provide their unique code (such as a phone number) to redeem the dot without the need to enter in the required public and private keys in connection with a transaction. The unique code mentioned herein may be any number or may even be a word or series of letters and/or other characters and may not even be a number. The unique code may also be alpha-numeric as well.

Non-custodial wallets do not require the outsourcing of trust to an institution, so no institution can refuse to complete transactions. Transactions using non-custodial wallets are essentially censorship-resistant, as the user controls the private key. However, non-custodial wallets are not as easy to use as custodial wallets. When using a non-custodial wallet, users must remember that if they lose the private key, the coins or dots in the wallet are essentially lost forever. Misplacing private keys can be a costly mistake. Users must develop a set of practices to maximize security and protect private keys in order to enjoy the full benefits of a non-custodial wallet.

One aspect of this disclosure can include the users have non-custodial wallets in which case the users would need to provide the private and potentially public key to redeem a dot. However, a more preferred embodiment involves the wallets being custodial wallets to simplify the redemption process for the end user.

FIG. 2C illustrates a diagram 247 having a table 248 which stores data that correlates phone numbers with one or more of wallet identifiers (IDs) and NFT/dot IDs. Each wallet ID or NFT/dot ID can correspond to one or more blockchain networks 249. For example, the first two rows of the table 248 include a reference to the same phone number 1. The first entry correlates the phone number 1 to a wallet-ID-1 and an NFT/dot ID-1. One or more of the IDs in the first row can refer to data on Blockchain No. 1. When the entry is made with the phone number, the wallet-ID-1 is generated for that user and an NFT/dot is minted and those entries are added to the table 248. The data in the table 248 links the respective phone number with one or more of the wallets and zero or more dots within each linked wallet.

The same phone number 1 can also reference to a wallet-ID-1 and a different NFT/dot-ID-2. The NFT/dot-ID-2 (and/or the Wallet-ID) may refer to a different blockchain network 2. Another entry for a different phone number 2 can have its separate wallet-ID-2 and NFT/dot-ID-3 that can refer to the blockchain No. 2. Yet another entry can be for a phone number 3 that references a wallet-ID-3 and an NFT/dot-ID-4 which can be associated with yet a different blockchain No. 3 or any of the other blockchains as well. This table 248 provides an example of how the database can be structured to provide the necessary association of the user's phone number with the wallet and/or dots recorded in various blockchain networks.

The second entry for the phone number 1 can occur when someone “air drops” a dot into that user's wallet. If someone airdrops an NFT into wallet-ID-1, if the system can get the ID of the wallet and an ID of the dot, then the phone number can be tied to another wallet or the same wallet and another dot that is dropped into the Web3 wallet. The approach simplifies the approach of sharing dots with different people. Using this correlation between different wallets which can be associated with different blockchain networks can greatly simplify the overall process of receiving, sharing and using dots of various types.

In this regard, the airdrop process can be as simple as users airdropping photos or data from one mobile device to another. This is usually done by devices that operate a wireless protocol such as Bluetooth or the like. A neighboring receiving device can be identified on a transmitting device as a destination for the airdropped data. The receiving device, upon confirmation from the transmitting device, can accept the data and the data transfer occurs. In this case, a similar process can apply to airdropping a dot. In this case, differences might apply such as the user of the transmitting device might use the user interface to access the wallet and identify a dot to airdrop. Neighboring receiving devices might receive a signal from the transmitting device about the potential transfer. However, since it is more specific to sharing a dot, only those neighboring devices with the proper wallet capable of receiving the dot might show up on the transmitting device interface. Thus, other devices which might be capable of receiving photos or video only will not show up as they cannot receive the dot.

However, in another aspect, a potential receiving device that does not have the proper wallet might present the user of that device with an option to create the wallet and receive the dot. In that case, upon that confirmation being received, the receiving mobile device might be presented to the transmitting device as an option. The transmitting device user then can select the receiving device for the airdrop of the dot and the process can then cause the creation of a wallet on the receiving device, and the transfer of the dot to that wallet for use by the receiving device user.

In another aspect, similar to sharing a photo or video from a mobile device with another device via the sending user choosing a mode of communication such as a text, an email, a Dropbox folder, a social media network, or some other optional mode, the approach herein can also enable multiple different “rails” or modes of communication to share a dot. For example, the transmitting user might select a text application or email application and choose the recipient's phone number or email address for sending. The system may only present receiving users that have wallets or enable the creation of a wallet for the receiving user as described above. Then, data can be attached to a text or email or transmitted within the text or email that causes the transition of the dot to the wallet (if already creates) or causes the system to create a wallet on the recipient device to receive and store the dot.

When the airdrop recipient already has a wallet on their device, the system can associate the dot with the new unique code for redemption in the future. When the wallet is created as part of the airdrop process, then the system will receive from the recipient or from their device the unique code to be associated with the wallet and the dot for future redemption.

FIG. 2D illustrates a method 250 from the standpoint of the server device 205 or business logic 232 and associated systems. The method can include one or more steps of receiving, at a server device having at least one processor, data associated with a user computing device, the data being associated with claiming a benefit (252), validating the data as being associated with a valid campaign to yield a validation (254), based the validation, transmitting, from the server device, a communication to the user computing device that launches a messaging application on the user computing device, creates and prepopulates a message ready for the user to send (256) and receiving, based on the user confirming to send the message from the user computing device, the message from the user computing device, the message including a unique code associated with the user computing device (258). The message can also include a hyperlink that accesses a computer server with the necessary data such as the phone number and other data. The method can include minting a dot associated with the benefit in connection with the data, wherein the dot is recorded on a blockchain network that includes a distributed set of nodes operating a distributed consensus algorithm and records transactions on a distributed ledger such that each transaction is immutably recorded (260), linking the dot to a wallet for the user via the unique code associated with the user computing device (262) and transmitting a confirmation response to the user computing device to confirm that the user has claimed the benefit (264).

The confirmation response can include confirming that the unique code associated with the user computing device is a phone number for the user computing device. The message can be a text message that, when received at the server, identifies a phone number as the unique number. Other message protocols can be used as well in which metadata identifying the phone number is provided as part of the message, such as an email. As the short messaging service (SMS) already identifies the sending phone number, other services have to be modified to add metadata identifying the phone number or other unique code to use for the wallet or dot. The message can be configured to be sent to a mobile phone number associated with the server device 205. The wallet can include a Web3 wallet or some other type of wallet. The dot can be a redeemable dot in the sense that there is a benefit of some sort, such as a discount or financial benefit, available to the user when they redeem the dot.

The message may be a first message from the user computing device at the server device 205. In this case, upon receiving the message, the wallet does not yet exist for the user computing device 201. In order to handle this scenario, the method further can include creating the wallet 240 and linking the wallet 240 to the unique code associated with the user computing device 201. This and the creation of a dot can occur as part of a single step initiated by one or two interactions of the user with the user computing device.

Minting the dot associated with the benefit in connection with the data can occur after creating the wallet and linking the wallet 240 to the unique code associated with the user computing device. As noted above, the creation of the wallet can also occur in connection with an airdrop operation of transferring a dot from one mobile device to a receiving mobile device that initially does not have the proper wallet for receiving the dot.

The data mentioned above can be generated based on one or more of the user computing device 201 receiving a scan of a QR code or visual object, a click on a link on a display of the user computing device 201, a voice interaction with the user computing device 201, a multi-modal interaction with the user computing device 201, a biometric interaction with the user computing device 201, a fingerprint interaction with the user computing device 201, a facial recognition interaction with the user computing device 201 or a near-field communication interaction with the user computing device 201. The data can be generated at the user computing device 201 or a server 205 delivering a user interface to the user computing device 201. As noted above, the interactions as part of the process can include any confirming or user identity-verifying transactions such as one or more of a button click or series of button clicks, a fingerprint metric, facial recognition, gesture recognition, location-based verification, any other biometric confirmation of identity, voice identification, multi-modal input and so forth. Any such input can be used to create the wallet, create or mint a dot and/or to redeem a dot.

The method can also include sending a cookie to a browser operating on the user computing device 201, the cookie identifying the wallet 240 or the user phone number or unique code that can be accessed for future transactions. The system then will know that the browser belongs to a particular phone number or unique code and the next time a QR code is scanned or a link is clicked on, the redemption system 230 can know who the user us by accessing the data in the cookie and obtain the unique code that way.

The benefit associated with the dot can be configured for the user based on one or more of historical information about the user, demographic information about the user, a purchasing history of the user, historical dot sharing information about the user, a location of the user, a time of day, a time of year, information about one or more of family and friends of the user, a pattern associated with the user or a limit on how many other users the dot can be shared with. Such user information is stored in a user data profile or database.

An example system can include one or more processors and a computer-readable storage medium storing instructions which, when executed by the one or more processors, causes the one or more processors to perform operations. The operation can include one or more of receiving data associated with a user computing device, the data being associated with claiming a benefit, validating the data as being associated with a valid campaign to yield a validation, based the validation, transmitting a communication to the user computing device that launches a messaging application on the user computing device, creates and prepopulates a message ready for the user to send, receiving, based on the user confirming to send the message from the user computing device, the message from the user computing device, the message including a unique code associated with the user computing device, minting a dot associated with the benefit in connection with the data, wherein the dot is recorded on a blockchain network that includes a distributed set of nodes operating a distributed consensus algorithm and records transactions on a distributed ledger such that each transaction is immutably recorded, linking the dot to a wallet for the user via the unique code associated with the user computing device and transmitting a confirmation response to the user computing device to confirm that the user has claimed the benefit.

FIG. 2E illustrates a method 270 from the standpoint of the user computing device 201. The method 270 can include one or more of receiving, at a user computing device, an interaction associated with a user that initiates a request associated with a benefit (272), transmitting the request to a server device (274), receiving, based on the request, a communication from the server device (276), initiating, based on the communication, a messaging application on the user computing device (278) and generating, via the messaging application, a message prepopulated for transmission to the server device (280). In another aspect, the message may be a communication via a hyperlink. Upon a confirmation from the user to send the message, the method can include transmitting the message to the server device 205, wherein the server device 205 identifies via the message a unique code associated with the user computing device, mints a dot associated with the benefit and stores the dot in a wallet associated with the unique number, wherein the dot is recorded on a blockchain network that includes a distributed set of nodes operating a distributed consensus algorithm and records transactions on a distributed ledger such that each transaction is immutably recorded (282) and receiving a confirmation response at the user computing device to confirm that the user has claimed the benefit (284).

The communication can indicate that the server device 205 has validated the request as being associated with an active campaign that enables the benefit. The unique ID can include a phone number associated with the user computing device 201.

FIG. 3A illustrates a redemption scenario 300 in which the consumer device 201 includes a graphical user interface 304 and the consumer device 201 is on an e-commerce checkout page. The state of the structure of FIG. 3A assumes that the user's wallet 240 has been created and there is at least one dot contained therein. The user can then proceed with the following redemption process. The user can enter in a phone number (or the unique code associated with the mobile device 201) and confirm the entry 302 by interacting with the “apply” object or in some other manner. The e-commerce website 301 has a redemption system integration installed in which if the proper 10 digit or other formatted proper unique code or alpha-numeric data is entered, then the redemption system logic flow applies 306. Javascript or other computer programming language on the e-commerce website 301 will call the redemption system server 205. The redemption system or server device 205 will receive the request 310 from the e-commerce website 301 and provide the unique code and a brand ID at point C. The processing by the server device 205 is then shown in FIG. 3B.

The server device 205 receives a discount response at point D from FIG. 3B and provides the data to the server device 205. The server device 205 returns the discount for that brand which is associated with the unique code 312. The e-commerce website 301 then applies the discount to the purchase 314. The consumer device 201 then makes the payment and finishes the transaction 316. The server device 205 then burns the dot if it is a one-time use dot 318. If the dot is not a one-time use, then the dot can be altered or noted that a use of the dot has been applied and the remaining available use or uses of the dot can be updated. For example, if the user is capable of using the dot three times, then the state of the dot can indicate that two more uses of the dot are available after the transaction. After those two additional uses, then the dot would be burned. Burning the dot means destroying it. There can be a number of different ways to achieve burning the dot. One way is to send the dot to a verifiably unspendable address, which eliminates the dot from the blockchain. In some cases, transactions leading up to the burn will remain on the ledger.

A dot can be shared at any state before it is burned. For example, a dot may be structured for three uses or three discounts on a product. The first user of the dot may use it once or twice thus leaving at least one additional use available. The first user can airdrop or share the dot with a second user who then can consume the remaining use of the dot before it is burned.

In another aspect with respect to FIG. 3A, the assumption might be that there is no dot held in the wallet. If there is no dot and the user lands in a checkout page or cart, they may see in a redeem option to enter a phone number. In that scenario where the user has entered their phone number into a redeem field in a cart or as part of a checkout process, the system may determine that there is no dot within a wallet or that they may not even have a wallet, then if they do not, the system can initiate an introductory flow to bring the user on-board to the system to perform one or more of creating a new wallet and minting a dot to place in the wallet or if a wallet exists, then a dot can be minted and placed within the existing wallet. The introductory process can also include providing multiple dots with various benefits that can also be related to each other like a first type of dot for a dinner and a second type of dot for a related activity like going to batting cage or other activity.

FIG. 3B shows the business logic process and blockchain or redemption system 330 from the standpoint of dot redemption. At point C from FIG. 3A, the unique code and brand identification are provided to the business logic 232 and the database 234 including the data regarding the consumer phone numbers 236 (or data of other unique code) is referenced to verify the proper number. The user's unique code links to the consumer's wallet 240. The system confirms through the unique code that the blockchain 242 and/or the wallet 240 hold the proper dot associated with the unique code and that the discount or other benefit is available. Once the confirmation or validation of the dot and the benefit are confirmed, the business logic 232 provides at point D the discount or promotion response and returns to FIG. 3A. The dots can be associated with any benefit such as a discount, coupon, giftcard or redeemable financial or other reward. For example, the dot can be used to gain access to a building or an event or may grant some kind of privilege such as better seating or services. Any benefit can be tied to the dot and as noted above, the benefit can also be in connection with a separate blockchain transaction such as can be related to a payment or healthcare services.

FIG. 3B also shows an artificial intelligence or machine learning model 332 that can be configured as part of the redemption system 330 or business logic 232. The model 332 can be trained on data regarding the user 334. The user data 334 can be, for example, a history or pattern for users in which threshold discount or benefit values can identify when a particular user may decide to accept a benefit or discount. For example, one user may never use a discount at 5% but once is raised to 10%, the user will take advantage of the benefit. Thus, once the phone number 236 of the user is confirmed and a dot exists in their wallet, or upon creation of the dot, the terms or characteristics of the dot can be tailored to the individual user. Not everyone, in other words, will receive the exact same T-shirt discount but based on the data from the AI/ML model 332, the discount may be determined for the particular user.

The dynamic nature of the NFT or dot can be more flexible as well. For example, one user may get a higher discount to urge that user to claim the benefit. Another user might get a set of benefits of different types, such as a discount plus a dinner reservation at a restaurant. Users have different touch points or desires and the ability to configure a dot for a user's interests goes beyond just increasing a discount percentage.

Other benefits or characteristics may also be tailored for the user. For example, the user may only desire to share a dot with three friends. Each friend can have a curated share of a dot. The configuration of the dot might be that a first user can share the dot with three friends based on their patterns or history of sharing 334 while a second user may be able to share the dot with five friends. The redemption system 330 can therefore have data to help tailor the discount or other characteristics of dots to use for various benefits to users. When users share dots (benefits), then both the giver and the receiver feel more positive to each other and there is a social media aspect to sharing benefits through dots.

Sharing can also be tied to a social media network as well, such as through Facebook or Instagram. For example, a link or data can be provided to a social media network that the user has a wallet 240 that contains a dot that is shareable. Perhaps, in one aspect, the link to the social media network is only provided if the dot has the sharable characteristic. Then, users could gift or share the dot or a curated portion or share of the dot with other friends.

In one example, a method could include receiving an interaction from a user with an object such as a QR code or an object on a display screen. There may be a promotion that is shareable with other friends as part of the dot related to the benefit. The user may receive a text, or as part of the user interface or user interaction when they interact with an object, a field or fields might be presented in which the user can fill in the referral data for one, two, three or more friends. For example, in a “to” field of a text, email or other message, the user can add friends from their contact list and send them the text and share the dot in this manner. Then, to process their receiving the benefit via the sharable dot, each of the friends receives the text which is configured for them to accept the dot and if they are new to the redemption system 330, and if they confirm their desire to receive the benefit, a new wallet will be onboarded for them and store the dot for their use. The friend will thus interact with the text or social media interaction to accept the dot and/or create a wallet where necessary with minimal interaction such as through one or two clicks. Friends who already have a wallet will simply have the dot added to their wallet for their use. In each case, the friend's phone number or other unique code will be used to associate the dot with the proper user and wallet. Users can become MICRO-influencers through sharing benefits via the dots. MICRO influencers influence perhaps around one thousand people and can have certain dots based on their level of influence. A PICO influencer might influence like 3 people or a small number of people less than 20 or 50. There can be different levels of benefits provided to the user who shares the dot with one or more friends and characteristics of the friends chosen may also drive the enhanced benefits to the user who shares the dot. The different number of dots or types of dots or other benefits can relate to the level of influencer that a particular user is. For example, a certain friend may spend a large amount of money via social media commerce or on-line commerce. Knowing that data makes them a desirable “friend” to receive a benefit. Thus, the increased or enhanced benefits to the referring user may be included if they refer or share a dot with a high-value friend. In some cases, the benefit to the referring user needs to hit a certain threshold before they will share a dot with friends and thus the redemption system 330 can tailor the benefit to the proper level that will likely make the user share the dot with their friends. The AI/ML model 332 or other module can be used to evaluate such data and configure the particular structure of the benefit for the first user to entice them to claim the benefit, share the dot, or take some other action or combination of actions.

Furthermore, some influencers have followers that actually take advantage of the shared benefits through the dots. Thus, another aspect of how to grant benefits to a particular user can be the historical data or knowledge of truly how influential the users is in that their followers actually buy the products that they suggest or take advantage of the “influence” given. Thus, for users that are high value influencers, the types of dots, the number of dots, or the benefits associated with a dot are tailored to the influence level of that particular user. In order to enhance the value of benefits received for quality influencers, the approach might cause an influencer, if they are only allowed to share a benefit associated with a dot with three people (for example), then that influencer will likely share with friends that have an affinity for the benefit being offered.

The enticement could also be provided in stages. For example, a first enticement might be a discount of an additional 20% if they share the dot with two friends. At which point, another enticement might be offered such as a new type of benefit, such as a gift card to a restaurant, if they share the dot with two more friends. Thus, the tailored benefit could be staged to encourage the user to take a number of different actions.

The individual characteristic can be applied based on a user profile, historical data, pattern data 334, and/or applied via the AI/ML model 332 or other framework. Benefits can therefore be dynamic to individual users, groups of users, or may change based on different parameters such as a time of day, demand for benefits or a supply of benefits as well. The process can also be implemented as a form of gamification in which other interactions with the user might involve answering some questions, providing some data (which is always valuable) and then granted a certain level of benefit to the user based on their participation in some questions or games.

FIG. 3C illustrates a network 350 having a user computing device 201, a brand or company computing device 301 and a redemption system 330. The user device in one example can use its browser 352 to navigate to a website hosted by a brand server or company computing device 301. The user may be at a checkout page and desire to redeem a dot stored in the user wallet 240. The user may interact with a “redeem” object 354 to start the process. The company computing device 301 can include a custom software module or software application 356 that can enable the functionality disclosed herein. In a website scenario as shown in FIG. 3C, the user can select the object 354 or enter in their unique code into a “promo code” field on a checkout page and the indication of the desire to redeem the dot can be passed to the company computing device 301. The software application 356 can check their discounts or promotion codes for a confirmation that the discount is available. The software application 356 may or may not confirm whether the unique code is proper but may just confirm that they have that discount available and it is active. The company computing device 301 can communicate the unique code and the brand identification to the redemption system 330 which can then confirm that the unique code is in the system and can check if the dot is in the user's wallet 240. This information is linked through the unique code.

As shown in FIG. 3C, the redemption system 330 can then return the discount or promotion response, essentially telling the company computing device 301 that there is an NFT or dot to apply for that user and that it can be used for the transaction the user desires to make.

The user then will make a payment, which can be done using any known payment process such as an Amazon one-click purchasing process, Apple Pay, Google Pay, PayPal, Payment Request API, cryptocurrency payment, traditional manual checkout, and so forth. The benefit is applied for the transaction and the company computing device 301 notifies the redemption system 330 that the transaction is complete, the benefit was applied, and that the dot can be burned, or the transaction noted in connection with the dot and processed and recorded on the distributed ledger of the blockchain network 242. Any new state of the dot after the transaction can also be recorded on the blockchain, if the dot is not burned at that time.

Note that the use of the dot in this transaction does not mean that a cryptocurrency payment is being made. While dots are blockchain-based, they are used to track the application of a discount and not necessarily to make a cryptocurrency payment in connection with a fiat payment. For example, the user might be buying a $30 t-shirt with a 20% discount offered by the application of the dot. The seller will then charge the user $24 by applying the discount and the dot can be burned or destroyed indicating that it cannot be used again. The use of the dot is to track the discount available to the user via the immutable blockchain-based record and not necessarily to incur a cryptocurrency payment.

In some cases, the dot may trigger a cryptocurrency payment or transaction if that is part of the benefit provided. The use of “benefits” thus can encompass fiat transactions, cryptocurrency transactions, hybrid transactions where in the benefit might be of one type (like access to an event or a cryptocurrency payment for example) while the underlying transaction is of another type (like a payment for example). The dots can be configured to provide other benefits such as access to a building or space via an access dot, access to a membership through a membership dot, certain privileges via a privilege-based dot or ongoing benefits via an evergreen dot. These and other benefits can be provided which may or may not be purely monetary can be provided through the use of specifically configured dots for each benefit type. Dots can be linked, dynamic (in that they can change functions or have functions added or removed) and composable in various ways.

FIG. 3C can also be used to illustrate the application of this process in connection with an application downloaded on the user computing device 301 or in connection with an “App Clip” downloaded for a specific transaction and is offered by Apple or some other company. An “App Clip” relates to a one-time use or portion of a full application that is downloaded on-demand to a user device typically perform a single function like a payment. For example, the App Clip might be a 10 MB or 15 MB snippet of code associated with an application but is downloaded when a user scans a QR code or based on some other triggering operation. The App Clip will not be persistent on the user's desktop or mobile device as other applications are downloaded and available for later access.

In one scenario, the user is not necessarily navigating to a website but interacting with software and user interfaces stored in an application or available via a small App Clip. The user may enter in their phone number or unique code to receive a benefit in the application or App Clip user interface. The application or App Clip would then pass that data on to a back-end server which can be represented by the company computing device 301. The company computing device 301 then can use the software 356 to pass on the unique code and their brand identifier or other data to the redemption system 330 to confirm that the dot is in the proper user wallet 240 and return the discount data. There are minor differences between processing of data for a website application and the use of a local application downloaded on the user computing device 201. This disclosure covers both contexts to enable users to receive benefits through the use of dots.

FIG. 3D illustrates a point-of-sale (POS) scenario in which the user computing device 201 is used at a point-of-sale to provide a wireless communication link between a POS device 364 and the user computing device 201. An object 362 may be presented on a user interface indicating that a discount is available and that the user may desire to confirm the use of the discount or benefit. For example, a box of cereal may be scanned at a checkout counter and the company computing device 366 interacting with the POS device 364 may offer a benefit in connection with the box of cereal such as to use a dot to get a 10% discount. The user may select the object 362 to confirm that they want to redeem the benefit. They may manually add their unique code which then may be retrieved from a memory on the user computing device 201 such as a secure element as is used in Apple Pay or via a browser memory or cookie that contains the unique number. In any number of different ways, the unique code can be passed from the user computing device 201 to the POS device 364 so that it can then be passed to the company computing device 366 and then provided to the redemption system 330 for confirmation of the dot in the user wallet 240 and processing via the blockchain network 242.

In one aspect, the process of paying at the POS device 364 using a standard payment process such as Apple Pay or Google Pay can also initiate, by virtue of an additional capability of passing the phone number of the mobile user device 201 to the POS device 364. Once the POS device 364 receives the phone number, it can communicate with the company server 366 to further identify whether there are any benefits available via dots that can be added to the user's wallet 240. Thus, this automated process can be integrated into a POS payment system to easily enable new benefits associated with an in-store transaction.

One benefit of this approach disclosed herein is that it can integrate with other systems. For example, as phone numbers are so often easily remembered by people, and because phone numbers are used in other scenarios such as to provide discounts via a grocery store chain such as Safeway, the redemption system 330 disclosed herein can integrate into existing systems that use the phone number to identify discounts. When the unique code is the user's phone number, they can easily remember the number and enter into a discount code box, or provide it at a grocery store or when buying gas, and an integrated system can enable users to receive, claim or redeem dots stored in their user wallet 240. In this regard, when a user goes to a grocery store and enters their phone number as part of the grocery store loyalty program, the approach disclosed herein can include, based on the receipt of the telephone number, a check by the redemption system 330 of whether there are any promotions related to dots. A response can be provided in which an object is presented to the user either on a POS device 364 or on the user computing device 201 that a redeemable dot exists and whether they desire to claim the dot. FIG. 3D in this regard can thus represent a company business system 366 that operates multiple POS devices 364 and that operates a loyalty program. The connection between the company system 366 and the redemption system 330 can illustrate the integration of the company loyalty framework with the use of dot and user wallets 240 as described herein. Dot-based discounts can even be applied asynchronously in which loyalty transactions can be gathered through a period of time like a day and then sent as a batch to determine whether dot discounts are to be applied. This becomes possible because the same phone number is used for the loyalty program as for the dot discounts. Where necessary, reimbursements to user credit cards or other accounts can occur to achieve the discount or benefit.

The integration of this approach can include such features as modification of existing processes to enable the passing of the unique code as an additional part of the existing process. For example, to perform some of the payment processes such as Apple Pay and Google Pay and the like, application programming interfaces (APIs) are used to pass payment information such as a one-time use token. This data may be encrypted. In order to integrate the use of dots tied to mobile phone numbers as disclosed herein, such APIs can be modified to include a field for the phone number data which can then be sent to the redemption system 230 for processing or to perform the desired action, whether it be wallet onboarding, creating of a dot, use of a dot or a portion of the dot capability, or burning the dot. Thus, for example, while a user interface presents an option to pay with Apple Pay, or Google Pay, etc., another object can be included which asks if a redeemable dot should be applied to this payment. If the user interacts with the object to confirm use of the dot, then the phone number or unique code associated with the dot can be passed as part of the other data pass to accomplish the payment. In this regard as well, the biometric or other verification process can also be used to confirm or verify the identity of the user not only for the payment itself, but the accompanying benefit from the dot.

Such an integrated approach can also work in various different types of payment processes. Apple Pay works differently for in-store POS sales, in-application processes and on-line purchasing processes. In each of these different scenarios, an additional field or data added to a token that is passed in connection with a payment can enable the inclusion of a claiming or redemption of a dot benefit as described herein. The processing on the user computing device would be modified to capture the unique code. The API or other communication protocol would be modified to include the unique code and the back-end server of a merchant or other entity would be modified to receive the unique code and interact with the redemption system 230 to process the dot associated with the unique code.

The approach can enable the phone number to be a link between various types of rewards or benefits that is currently not possible. Plus, such an approach can leverage existing loyalty program infrastructure and expand upon its abilities. In one aspect as well, rewards such as a certain amount of money off gas purchase or other rewards such as airline mile can also be added to the benefit associated with a dot and thus its use can be expanded upon. For example, a user might earn fifty cents of each gallon of gas but want to share that benefit with a friend. The user could add that benefit to a dot and store it in their wallet 240. Then the user could share that dot with a friend and that benefit (50 cents off) would be transferred to the friend based on what the giver earned through the company loyalty program. The accounting can be coordinated with the company such that the reduction in gas no longer applies to the loyalty customer but to their friend which may or may not be a part of the company loyalty program. Through the integration, the process can enable such benefits to be received by a user not a party to the loyalty program.

FIG. 3E illustrates a redemption method 370 that can be implemented through the computing devices disclosed herein. The method 370 can be performed by a redemption system 330 as shown in FIG. 3B and can include one or more of receiving an indication from a company computing device of an intent of a user to apply a benefit from a dot held in a user wallet, wherein the indication includes a unique code associated with a user computing device and a brand identifier (372), confirming, based on a link between the unique code and the user wallet, that the user wallet contains the dot and that the benefit is available to yield a confirmation (374), based on the confirmation, returning to the company computing device a response identifying the benefit to apply the benefit to an action performed by the user (376) and performing an action on the dot contained in the user wallet including either burning the dot or performing another action on the dot associated with the action performed by the user (378).

The action performed by the user can include a purchase of a product or service by the user to which the benefit applies. The company computing device 301 can be associated either with a point-of-sale device, an application, an App Clip, or a website accessed by the user computing device 201. The unique code can be a telephone number associated with the user computing device. The indication can relate to the user entering the telephone number into a field on a website presented by the company computing device in connection with a purchase. The indication can also relate to a point-of-sale purchase using the user computing device interacting with a point-of-sale device connected to the company computing device in which the telephone number is communicated from the user computing device to the point-of-sale device.

FIG. 3F illustrates another method 380 from the standpoint of the redemption system 330. The method 380 can include one or more steps of receiving an indication from a company computing device of an intent of a user to apply a benefit from a dot held in a user wallet, wherein the indication includes a phone number assigned to a user computing device and a transaction identifier associated with a transaction (382), confirming, based on a link between the phone number and the user wallet, that the user wallet contains the dot and that the benefit is available to yield a confirmation (384), based on the confirmation, returning to the company computing device a response identifying the benefit to apply the benefit to an action performed by the user (386) and performing an action on the dot contained in the user wallet including either burning the dot or performing another action on the dot associated with the transaction completed by the user (388). The action performed by the user can include that the transaction is a purchase of a product or service by the user to which the benefit applies.

The company computing device 301 can be associated either with a point-of-sale device 364, an application, an App Clip, or a website accessed by the user computing device 201.

FIG. 3G illustrates another method 390 from the standpoint of the user computing device 201. The method can include one or more steps of receiving an indication on a user computing device of an intent of a user to apply a benefit from a dot held in a user wallet (392), transmitting a request to a company computing device either directly or through a point-of-sale device, the request including a unique code associated with the user computing device, wherein a redemption system receives the unique code and a data associated with a transaction from the company computing device and verifies, based on a link between the unique code and the user wallet, that the user wallet contains the dot and that the benefit is available to yield a verification (393) and, based on the verification, receiving from the user and on the user computing device a confirmation to apply the benefit to an action performed by the user, wherein based on the confirmation, the redemption system performs an action on the dot contained in the user wallet including either burning the dot or performing another action on the dot associated with the action performed by the user (394). The intent of the user to apply the benefit from the dot held in the user wallet is in connection with a transaction.

An example user computing device includes a processor and computer-readable memory storing instructions which, when executed by the processor, cause the processor to perform operations including: receiving an interaction associated with a user that initiates a request associated with a benefit, transmitting the request to a server device, receiving, based on the request, a communication from the server device and initiating, based on the communication, a messaging application on the user computing device.

The operations further can include generating, via the messaging application, a message prepopulated for transmission to the server device, upon a confirmation from the user to send the message, transmitting the message to the server device, wherein the server device identifies via the message a unique code associated with the user computing device, mints a dot associated with the benefit and stores the dot in a wallet associated with the unique number, wherein the dot is recorded on a blockchain network that can include a distributed set of nodes operating a distributed consensus algorithm and records transactions on a distributed ledger such that each transaction is immutably recorded and receiving a confirmation response at the user computing device to confirm that the user has claimed the benefit.

FIG. 3H shows another method 395 that relates to processes performed at the redemption system 330. The method 395 can include one or more of receiving, at a company computing device, an indication from a user computing device of an intent of a user to apply a benefit from a dot held in a user wallet, wherein the indication can include a unique code associated with a user computing device and a brand identifier (396), transmitting the unique code and a transaction identification to a redemption system, wherein the redemption system confirms, based on a link between the unique code and the user wallet, that the user wallet contains the dot and that the benefit is available to yield a confirmation (397), based on the confirmation, receiving at the company computing device a response identifying the benefit to apply the benefit to an action performed by the user (398) and applying the benefit to a transaction of the user and associated with the benefit, wherein the redemption system performs an action on the dot contained in the user wallet including either burning the dot or performing another action on the dot associated with the transaction (399).

An example redemption system can include a processor and computer-readable memory storing instructions which, when executed by the processor, cause the processor to perform operations including: receiving an indication from a company computing device of an intent of a user to apply a benefit from a dot held in a user wallet, wherein the indication can include a unique code associated with a user computing device and a brand identifier, confirming, based on a link between the unique code and the user wallet, that the user wallet contains the dot and that the benefit is available to yield a confirmation, based on the confirmation, returning to the company computing device a response identifying the benefit to apply the benefit to an action performed by the user and performing an action on the dot contained in the user wallet including either burning the dot or performing another action on the dot associated with the action performed by the user.

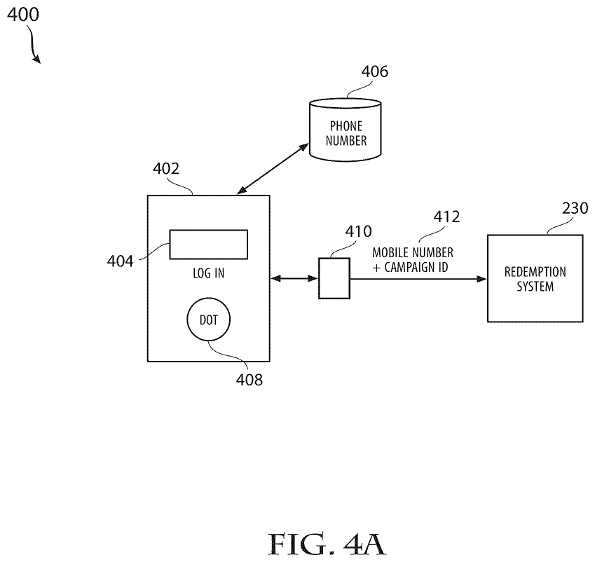

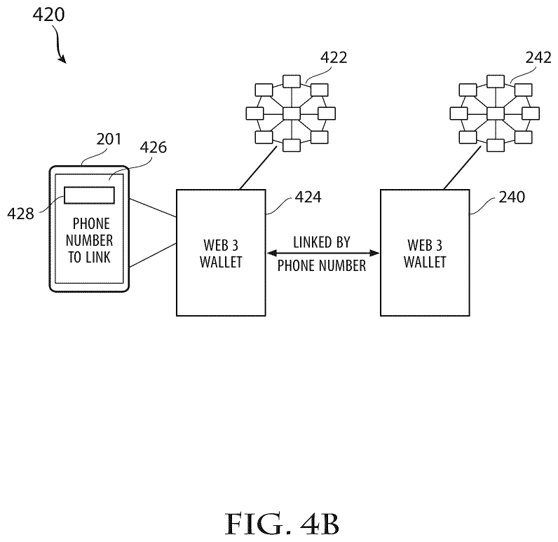

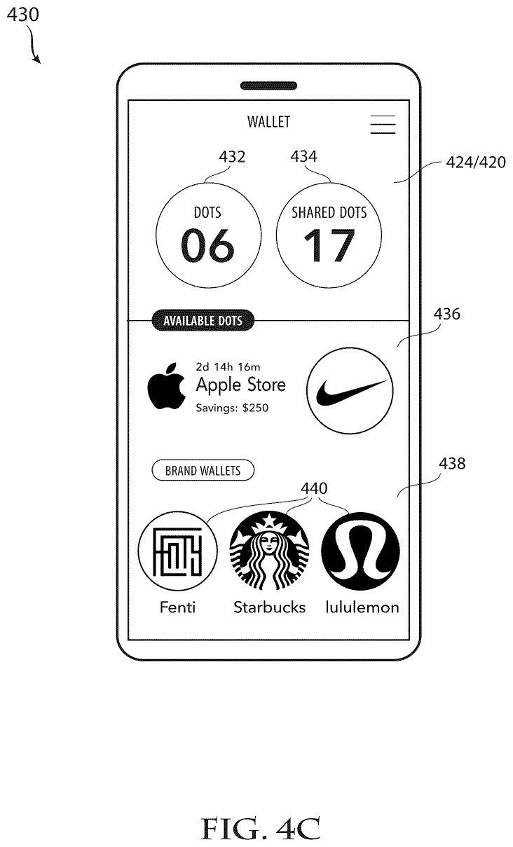

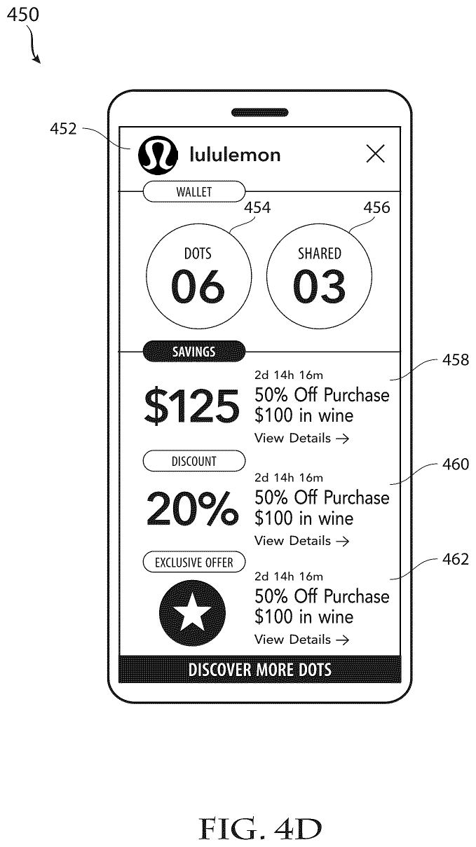

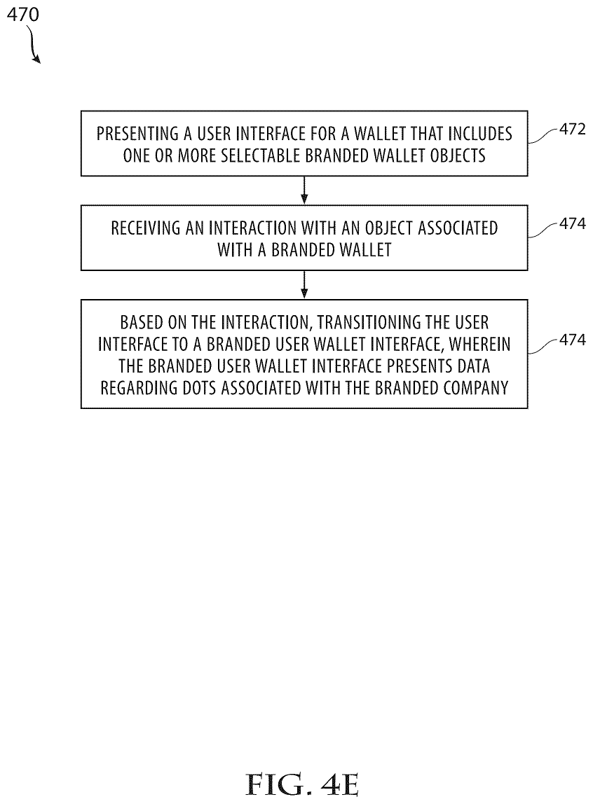

FIG. 4A illustrates a scenario 400 in which other approaches could be used to create a wallet and/or generate or use a dot from the wallet. In this case, assume that a graphical user interface 402 can operate on any device and not just a mobile user computing device. The associated device could be a desktop or laptop computer, an Internet of Things (IoT) device or any computing device. The core issue is whether a message or communication can be constructed easily from a login 404 or other user interface interaction in which a dot that is stored 406 in a database or wallet can be accessed. The dot is associated with a phone number or other unique code. The novelty is that access to the dot can be triggered in a number of different interactions. For example, often with a login to a website like Google, a user's mobile phone number is stored as part of a two-part authentication process where an access code is texted to the user to then entered into an input field 404 to confirm their identity. The disclosed system in such a case could modify that process at the back-end server 410. Rather than having a text sent to the user's mobile device, the back-end system 410 could construct a text message 412 or based on the user interaction with a graphical object the system could activate a link to the business logic 242 that would include the necessary payload such as the phone number. The hyperlink that will have a phone number is going to be received at the business logic 242.

In one scenario, the user could click on an object 408 while using a user interface and that could cause a series of steps to occur. For example, assume a user is logged into the Chrome browser or the Safari browser where a mobile phone number is stored 406 in the browser or in another database or computer-readable memory, and clicks on an object 408 to either receive a redeemable dot or create a wallet and mint a dot. A message 412 can be created and transmitted from a mobile phone in which case the messaging protocol shares the sender's phone number by virtue of sending the message. In the alternative, the system 410 may create, via the browser or back-end server 410 that obtains the stored mobile phone number for the user, a message or a link for sending or transitioning to the business logic 242. It can be a pseudo message but structured such that when that message or communication is received, it communicates the mobile phone number of the user to the business logic 242 to enable it to then create the wallet and/or mint the dot and store it in the wallet. This process thus connects the wallet and the dot to the mobile phone number (or other unique code).

This approach enables a convenient one or two click wallet/NFT/dot creation process. For example, one click can be an interaction with an object that indicates that upon interacting with the object, a wallet and/or dot can be created for the user. Upon interacting with the object, the user may then be presented with the message configured to be sent to the business logic 232 and from the user's mobile phone (whether on the mobile phone or another computing device) and the “second click” can cause the message to be sent. The receipt of the message by the business logic 232 causes the creation of the wallet for first time users and the minting of a dot for a benefit of some sort. The dot is then stored in the wallet. The wallet is an address and stores the data about who owns the respective dot. Once of course the wallet is created, multiple dots can be stored therein.

While one or two “clicks” are referenced above, they can also cover any other single or multi-modal types of transactions. For example, the user may interact with their mobile device 201 to scan an object such as a QR code as shown in user interface 202. The scanning of the QR code can be one interaction that causes the mobile device 201 to generate the message configured or prepopulated to be sent to the business logic 232 and that one way or another will identify the unique data (phone number) of the user mobile device.

In this manner, for example, a user may take their mobile device 201 and walk through a store scanning objects such as QR Codes or near-field communication components or any other type of object, image or device that can cause the mobile device 201 to initiate the processes disclosed herein. Again, it can be a physical or wireless interaction between the mobile device 201 and an object or it can be initiated via a link or an object presented on a website that a user interacts with via a touch-sensitive screen or mouse interaction and click. Other modalities such as speech input, multi-modal input, motion input, gestures whether on a display or in the air via a hand-gesture or other gesture can be interpreted to initiate the operation of creating the wallet and/or minting a dot for a benefit.

In one aspect, the business logic used to implement the dots as disclosed herein can develop into a larger “hub” application which means that as the process is so simple to receive or claim, and then redeem, dots, that other processes may start to be added to the business logic such that payments in fiat or cryptocurrency could be added, banking, food ordering, reservations, map applications, social media application, blockchain-based processes, and so forth could be incorporated into the application. In this regard, part of this disclosure includes the redemption system 330 as including other functionality including the ability to create new wallets, associate them with the user's unique number, and add dots to the wallet. Indeed, the functionality built into the dots could also expand into these other spaces such that the benefits of a given dot can span a discount, a reservation, a payment, a reverse payment, a bonus for sharing, and the ability to share with others a portion of the disparate types of capabilities or benefits built into a given dot. For example, with an expanded application or business logic, the services available to the system might include the ability to obtain discounts but also to get a first-tier reservation at a restaurant. The benefit might be to get a 10% discount on a product but if you share the dot with three people, then you get a reservation at a top restaurant for a prime-time dinner. The dot could include a discount for a first product and a gift card that pays fully for a second related product. In one aspect, all these features are contained within a single dot and in another case a payment dot might be internally connected to a reservation dot such that when one of the dot's transactions has been finalized and performed, then that dot can be burned and the other remains alive until its benefit is experienced.

FIG. 4B illustrates a linking of different types of wallets between one Web3 wallet and another Web3 wallet. In general, these could be two different types of wallets that are typically not compatible. Note that a Web2 wallet can relate to an older state of the internet, which has more user-generated content and usability for end-users compared to its earlier incarnation, Web 1.0. Web 2.0 does not refer to any specific technical upgrades to the Internet; it refers to a shift in how the Internet is used. In one example, a Web2 wallet might have certain characteristics and capabilities and a Web3 wallet might expand upon those capabilities and add new capabilities such as rather than being a basic database, a Web3 wallet can be decentralized. The framework 420 shown in FIG. 4B relates to how to use the unique code to link two Web3 wallets. Assume a user desires to “air drop” a reward into a wallet (Web3 wallet) of a friend. But assume that the reward is associated with a dot stored in a first wallet, such as a Web3 wallet 240. A certain type of blockchain network 242 may be associated with this wallet. The second wallet of the friend is of a second type such as a Web3 wallet 424 associated with the same or a different blockchain network 422 for recording transactions. If the user wants to give their friend a dynamic promotional code or redeemable dot, it would be helpful to simplify the process if they could link these wallets. In one example, the Web3 wallet 424 includes in its internal browser 426 on a user device 201 that enables the user to interact with the wallet via an input field 428 or selectable object. If the user types in their phone number into the input field 428, there is a process that can be initiated to link the Web3 wallet 240 to Web3 wallet 424. The backend system knows in this case based on the phone number associated with the user has a Web3 wallet 240 or a wallet configured with the redemption system 330. Any new reward that comes to or is airdropped into the Web3 wallet 424 can be linked to and thus used via the Web3 wallet 240.

In one example, assume that a first user having a Web3 wallet 240 that is part of the redemption system 330 desires to share a dot with a second user who has a wallet that is not registered or known to the redemption system 330. In that case, the first user can select the second user in any manner (such as from their wallet 240, or by pulling up a text and choosing the recipient of the text, email or other communication) and provide a link to the dot they desire to share. For example, a user interface in the wallet 240 can enable the user to select a contact and share a dot with that contact (the second user). Assume that the second user does not however have a wallet that is connected to the redemption system 330. The first user can send a message or “airdrop” the dot into the second user's wallet as follows. The second user gets a text or notification in some manner that includes a link associated with the message or a graphical object. The link is associated with the dot. The message or graphical object instructs the user to claim the dot in their wallet by providing their phone number or a unique code used for redeeming dots. The second user types in the unique code and enters the data. The data is transmitted comes to the redemption system 330. A wallet ID can be provided as well for the second user. The system can then link the unique code to the second user's wallet. In this manner, the second user's wallet can become registered with the redemption system 330 and enabled to receive and redeem dots through the system 330.

A Web2 wallet is essentially a database. While the airdrop feature is generally described as linking two Web3 wallets, there also can be a linking between a Web2 wallet and a Web3 wallet. However, an airdrop type of operation is preferably capable of occurring between two Web3 structured wallets. In a Web2 wallet scenario, a unique entry in a table can provide a linking or correlation between data in a Web2 wallet and data in a Web3 wallet. The table can also store unique identification information associated with an identification for NFT or dot, or an identification for a wallet.

FIG. 4C illustrates an example user interface to a wallet 430 that can include further different brand wallets and other features. The user interface can show the dots in the wallet 432, and the dots that are shared 434. A portion of the user interface can inform the user about available dots 436 and another portion 438 can connect the user to brand wallets 440. Example brand wallets include a Fenti Wallet, a Starbucks Wallet and a Lululemon Wallet. When a user wanted to incorporate a particular branded wallet, they can swipe or otherwise interact with the object showing the respective wallet to reveal more about the particular wallet.

The branded wallet interface 450 is shown in FIG. 4D. The brand wallets can offer rewards directly to users and the brand wallet 450 might hold their dots. In this regard, the wallet 424, 420 can include other subwallets 440 which can be branded from different companies. In this manner, particular brands can market or present offers to the user via the presentation of various branded wallets 440 all within the primary or global wallet 424, 420 as shown in FIG. 4C. In this manner, when a user interacts with or selects a particular wallet 440, then the user interface can transition to the logo of that brand 452 and provide the data for that particular wallet or sub-wallet 450, such as the number of dots 454, the number of shared dots 456, the savings the user has experienced 458, the discounts offered 460 and other exclusive offers for that brand 462. The new user interface 450 enables the user to interact with that brand's wallet using the dot concept disclosed herein but focused just on dots and benefits available through that brand. The user can then return up a level to the user interface of FIG. 4C to see other brand wallets to choose. Note that the structure of the sub-wallet for a particular brand is structured like the dot wallet but is branded for a particular company to provide them with more connection to the individual user. Brands can cross market to particular people based on user profile data regarding how influential they are.

FIG. 4E illustrates a method 470 related to the use of branded wallets. The method includes presenting a user interface for a wallet that includes one or more selectable branded wallet objects (472), receiving an interaction with an object associated with a branded wallet (474) and, based on the interaction, transitioning the user interface to a branded user wallet interface, wherein the branded user wallet interface presents data regarding dots associated with the branded company (476).

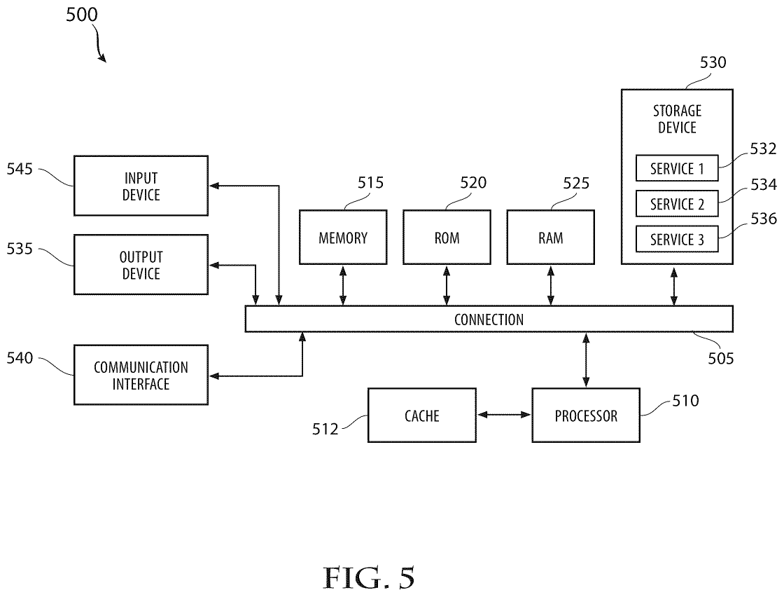

FIG. 5 illustrates a computing system architecture 500 including various components in electrical communication with each other using a connection 505, such as a bus. Example system architecture 500 includes a processing unit (CPU or processor) 510 and a system connection 505 that couples various system components including the system memory 515, such as read only memory (ROM) 520 and random access memory (RAM) 525, to the processor 510. The system architecture 500 can include a cache 512 of high-speed memory connected directly with, in close proximity to, or integrated as part of the processor 510. The system architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions.

Other system memory 520, 525 may be available for use as well. The memory 515 can include multiple different types of memory with different performance characteristics. The processor 510 can include any general-purpose processor and a hardware or software service, such as service 1 532, service 2 534, and service 3 536 stored in storage device 530, configured to control the processor 510 as well as a special-purpose processor where software instructions are incorporated into the actual processor design. The processor 510 may be a completely self-contained computing system, containing multiple cores or processors, a bus, memory controller, cache, etc. A multi-core processor may be symmetric or asymmetric.

To enable user interaction with the computing system architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing system architecture 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the system connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances the present technology may be presented as including individual functional blocks, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

1. A method comprising:
receiving, at a server device having at least one processor, data associated with a user computing device, the data being associated with claiming a benefit;
validating the data as being associated with a valid campaign to yield a validation;
based the validation, transmitting, from the server device, a communication to the user computing device that, without manual user intervention, launches a messaging application on the user computing device, creates a message and prepopulates the message ready for a user to send;
receiving, based on the user confirming to send the message from the user computing device, the message from the user computing device, the message comprising a unique code associated with the user computing device, wherein the unique code associated with the user computing device is a phone number for the user computing device;
minting a dot associated with the benefit in connection with the data, wherein the dot is recorded on a blockchain network that comprises a distributed set of nodes operating a distributed consensus algorithm and records transactions on a distributed ledger configured on the distributed set of nodes such that each transaction is immutably recorded;
linking the dot to a wallet for the user via the phone number associated with the user computing device; and
transmitting a confirmation response to the user computing device to confirm that the user has claimed the benefit.

2. (canceled)

3. The method of claim 1, wherein the message is a text message that, when received at the server device, identifies the phone number as the unique code.

4. The method of claim 1, wherein the message is configured to be sent to a mobile phone number associated with the server device.

5. The method of claim 1, wherein the wallet comprises a Web3 wallet.

6. The method of claim 1, wherein the dot comprises one or more of a redeemable dot, an access dot, a membership dot, a privilege-based dot, and an evergreen dot.

7. The method of claim 1, wherein, when the message comprises a first message from the user computing device and upon receiving the message, the wallet does not yet exist for the user computing device, the method further comprises:
creating the wallet and linking the wallet to the unique code associated with the user computing device.

8. The method of claim 7, wherein minting the dot associated with the benefit in connection with the data occurs after creating the wallet and linking the wallet to the unique code associated with the user computing device.

9. The method of claim 1, wherein the data is generated based on one or more of the user computing device receiving a scan of a code, a click on a link on a display of the user computing device, a voice interaction with the user computing device, a multi-modal interaction with the user computing device, a biometric interaction with the user computing device, a fingerprint interaction with the user computing device, a facial recognition interaction with the user computing device or a near-field communication interaction with the user computing device.

10. The method of claim 1, wherein the data is generated at the user computing device or a server delivering a user interface to the user computing device.

11. The method of claim 1, further comprising:
sending a cookie to a browser operating on the user computing device, the cookie identifying the wallet for future transactions.

12. The method of claim 1, wherein the benefit associated with the dot is configured for the user based on one or more of historical information about the user, demographic information about the user, a purchasing history of the user, historical dot sharing information about the user, a location of the user, a time of day, a time of year, information about one or more of family and friends of the user, a pattern associated with the user or a limit on how many other users the dot can be shared with.

13. A system comprising:
one or more processors; and
a computer-readable storage medium storing instructions which, when executed by the one or more processors, causes the one or more processors to perform operations comprising:
receiving data associated with a user computing device, the data being associated with claiming a benefit;
validating the data as being associated with a valid campaign to yield a validation;
based the validation, transmitting a communication to the user computing device that, without manual user intervention, launches a messaging application on the user computing device, creates a message and prepopulates the message ready for a user to send;
receiving, based on the user confirming to send the message from the user computing device, the message from the user computing device, the message comprising a unique code associated with the user computing device, wherein the unique code associated with the user computing device is a phone number for the user computing device;
minting a dot associated with the benefit in connection with the data, wherein the dot is recorded on a blockchain network that comprises a distributed set of nodes operating a distributed consensus algorithm and records transactions on a distributed ledger configured on the distributed set of nodes such that each transaction is immutably recorded;
linking the dot to a wallet for the user via the phone number associated with the user computing device; and
transmitting a confirmation response to the user computing device to confirm that the user has claimed the benefit.

14. A method comprising:
receiving, at a user computing device, an interaction associated with a user that initiates a request associated with a benefit;
transmitting the request to a server device;
receiving, based on the request, a communication from the server device;
initiating, based on the communication, a messaging application on the user computing device;
generating, via the messaging application, a message prepopulated for transmission to the server device;
upon a confirmation from the user to send the message, transmitting the message to the server device, wherein the server device identifies via the message a unique code comprising a phone number that is associated with the user computing device, mints a dot associated with the benefit and stores the dot in a wallet associated with the phone number, wherein the dot is recorded on a blockchain network that comprises a distributed set of nodes operating a distributed consensus algorithm and records transactions on a distributed ledger configured on the distributed set of nodes such that each transaction is immutably recorded; and
receiving a confirmation response at the user computing device to confirm that the user has claimed the benefit.

15. The method of claim 14, wherein the communication indicates that the server device has validated the request as being associated with an active campaign that enables the benefit.

16. (canceled)

17. A method comprising:
receiving an indication from a company computing device of an intent of a user to apply a benefit from a dot held in a user wallet, wherein the indication comprises a unique code comprising a phone number associated with a user computing device and a brand identifier;
confirming, based on a link between the phone number and the user wallet, that the user wallet contains the dot and that the benefit is available to yield a confirmation;
based on the confirmation, returning to the company computing device a response identifying the benefit to apply to an action performed by the user; and
performing an action on the dot contained in the user wallet comprising either burning the dot or performing another action on the dot associated with the action performed by the user.

18. The method of claim 17, wherein the action performed by the user comprises a purchase of a product or service by the user to which the benefit applies.

19. The method of claim 17, wherein the company computing device is associated either with a point-of-sale device, an application, an App Clip, or a website accessed by the user computing device.

20. The method of claim 17, wherein the indication relates to one of the user entering the phone number into a field on a website presented by the company computing device in connection with a purchase or the indication relates to a point-of-sale purchase using the user computing device interacting with a point-of-sale device connected to the company computing device in which the phone number is communicated from the user computing device to the point-of-sale device.
